(19) United States
(12) Patent Application Publication
(10) Pub. No.: US 2025/0024154 A1
(43) Pub. Date: Jan. 16, 2025

(54) IMAGE FILE, INFORMATION PROCESSING APPARATUS, IMAGING APPARATUS, AND GENERATION METHOD

(71) Applicant: FUJIFILM Corporation, Tokyo (JP)

(72) Inventors: Toshiki KOBAYASHI, Saitama-shi (JP); Shoki KASAHARA, Saitama-shi (JP)

(73) Assignee: FUJIFILM Corporation, Tokyo (JP)

(21) Appl. No.: 18/897,028

(22) Filed: Sep. 26, 2024

Related U.S. Application Data
(63) Continuation of application No. PCT/JP2023/005309, filed on Feb. 15, 2023.

(30) Foreign Application Priority Data
Mar. 30, 2022 (JP) 2022-057531

(51) Int. Cl. H04N 23/695; G06F 16/783

(52) U.S. Cl. CPC H04N 23/695; G06F 16/7837

(57) ABSTRACT

An image file includes moving image data including a frame group and accessory information, in which the accessory information includes first accessory information and second accessory information, the first accessory information relates to all frames included in the frame group, and the second accessory information relates to a part of a plurality of frames in the frame group.

### CROSS-REFERENCE TO RELATED APPLICATIONS

This application is a continuation application of International Application No. PCT/JP2023/005309, filed Feb. 15, 2023, the disclosure of which is incorporated herein by reference in its entirety. Further, this application claims priority from Japanese Patent Application No. 2022-057531, filed Mar. 30, 2022, the disclosure of which is incorporated herein by reference in its entirety.

### BACKGROUND

### 1. Technical Field

The present disclosed technology relates to an image file, an information processing apparatus, an imaging apparatus, and a generation method.

### 2. Related Art

JP2021-177317A discloses a three-dimensional model construction system. The three-dimensional model construction system described in JP2021-177317A includes management means, collection means, generation means, and assignment means. The management means manages each of a plurality of mobile bodies and a user in association with each other. The collection means collects imaging data including accessory information related to imaging, which is obtained by performing the imaging by an imaging apparatus provided in each of the plurality of mobile bodies. The generation means generates a three-dimensional model by using the imaging data collected by the collection means. The assignment means assigns a reward to the user associated with the mobile body that has imaged the imaging data, in accordance with the imaging data used in generating the three-dimensional model by the generation means. Further, the generation means specifies, using accessory information included in new imaging data, an imaging region of an existing three-dimensional model corresponding to the new imaging data, and updates the existing three-dimensional model using the new imaging data according to a difference between a three-dimensional model generated from the new imaging data in the imaging region and the existing three-dimensional model.

### SUMMARY

One embodiment according to the present disclosed technology provides an image file, an information processing apparatus, an imaging apparatus, and a generation method capable of understanding a content of an image file without reproducing the image file.

A first aspect according to the present disclosed technology relates to an image file having the following configuration. That is, the image file according to the first aspect comprises moving image data including a frame group, and accessory information, in which the accessory information includes first accessory information and second accessory information, the first accessory information relates to all frames included in the frame group, and the second accessory information relates to a part of a plurality of frames in the frame group.

A second aspect according to the present disclosed technology relates to a generation method of generating an image file including moving image data including a frame group and accessory information, the generation method comprising an acquisition step of acquiring the moving image data, a first assignment step of assigning, to the image file, first accessory information that relates to all frames included in the frame group as the accessory information, and a second assignment step of assigning, to the image file, second accessory information that relates to a part of a plurality of frames in the frame group as the accessory information.

### BRIEF DESCRIPTION OF THE DRAWINGS

Exemplary embodiments according to the technique of the present disclosure will be described in detail based on the following figures, wherein:

FIG. 1 is a conceptual diagram showing an example of an aspect in which an imaging apparatus is used;

FIG. 2 is a block diagram showing an example of a hardware configuration of an electric system of the imaging apparatus and a function of a main unit thereof;

FIG. 3 is a conceptual diagram showing examples of a processing content acquiring moving image data, a processing content acquiring image recognition result information, and a processing content acquiring frame-related information;

FIG. 4 is a conceptual diagram showing examples of a processing content acquiring a frame-related information group by period, a processing content acquiring scene information, and a processing content acquiring a partial plurality-of-frame-related information;

FIG. 5 is a conceptual diagram showing examples of a processing content acquiring outline information and a processing content acquiring whole-related information;

FIG. 6 is a conceptual diagram showing an example of a processing content generating a moving image file including the moving image data and metadata;

FIG. 7 is a conceptual diagram showing an example of an aspect in which the frame-related information, the partial plurality-of-frame-related information, and the whole-related information are saved (recorded) in the moving image file as meta information;

FIG. 8 is a conceptual diagram showing an example of a processing content assigning the frame-related information to the moving image file;

FIG. 9 is a conceptual diagram showing an example of a structure of the image recognition result information;

FIG. 10 is a conceptual diagram showing an example of a processing content assigning the partial plurality-of-frame-related information to the moving image file;

FIG. 11 is a conceptual diagram showing an example of a processing content assigning the whole-related information to the moving image file;

FIG. 12 is a conceptual diagram showing an example of a structure of the metadata;

FIG. 13 is a conceptual diagram showing an example of a processing content of a control unit;

FIG. 14 is a flowchart showing an example of a flow of image file creation processing;

FIG. 15 is a conceptual diagram showing examples of a processing content including subject change information in frame-related information and a processing content including representative subject change information in the partial plurality-of-frame-related information, in the imaging apparatus according to a first modification example;

FIG. 16 is a conceptual diagram showing an example of a processing content acquiring geometric information, in the imaging apparatus according to a second modification example;

FIG. 17 is a conceptual diagram showing examples of a processing content including geometric change information in the frame-related information and a processing content including representative geometric change information in the partial plurality-of-frame-related information, in the imaging apparatus according to the second modification example;

FIG. 18 is a conceptual diagram showing examples of a processing content including angle-of-view change information in the frame-related information and a processing content including representative angle-of-view change information in the partial plurality-of-frame-related information, in the imaging apparatus according to a third modification example;

FIG. 19 is a conceptual diagram showing examples of a processing content including tracking-related information in the frame-related information and a processing content including representative tracking-related information in the partial plurality-of-frame-related information, in the imaging apparatus according to a fourth modification example;

FIG. 20 is a conceptual diagram showing examples of a processing content including pan-tilt information in the frame-related information and a processing content including representative pan-tilt information in the partial plurality-of-frame-related information, in the imaging apparatus according to a fifth modification example;

FIG. 21 is a conceptual diagram showing examples of a processing content including inertial sensor signal difference information in the frame-related information and a processing content including representative inertial sensor signal difference information in the partial plurality-of-frame-related information, in the imaging apparatus according to a sixth modification example;

FIG. 22 is a conceptual diagram showing examples of a processing content including recording time-related information in the frame-related information and a processing content including representative recording time-related information in the partial plurality-of-frame-related information, in the imaging apparatus according to a seventh modification example;

FIG. 23 is a conceptual diagram showing examples of a processing content including operation-related information in the frame-related information and a processing content including representative operation-related information in the partial plurality-of-frame-related information, in the imaging apparatus according to an eighth modification example;

FIG. 24 is a conceptual diagram showing an example of a processing content acquiring subject sensor information, in the imaging apparatus according to a ninth modification example;

FIG. 25 is a conceptual diagram showing examples of a processing content including the subject sensor information in the frame-related information and a processing content including representative subject sensor information in the partial plurality-of-frame-related information, in the imaging apparatus according to the ninth modification example;

FIG. 26 is a conceptual diagram showing an example of a processing content including separate moving image file information in the whole-related information, in the imaging apparatus according to a tenth modification example; and

FIG. 27 is a conceptual diagram showing an example of an aspect in which the image file creation processing is executed on an external device.

### DETAILED DESCRIPTION

Hereinafter, an example of embodiments of an image file, an information processing apparatus, an imaging apparatus, and a generation method according to the present disclosed technology will be described with reference to accompanying drawings.

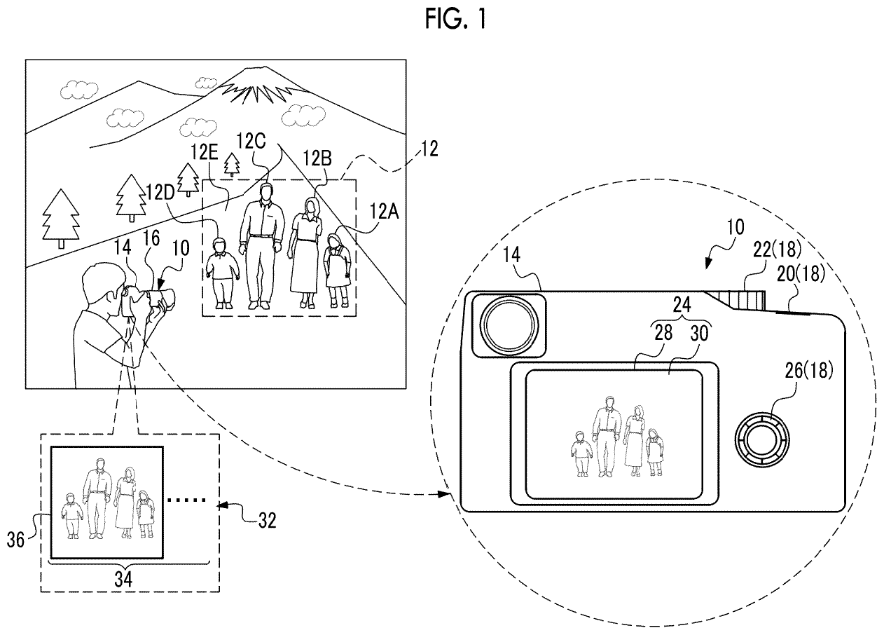

As shown in FIG. 1 as an example, an imaging apparatus 10 images an imaging target region 12 designated as a subject. A range of the imaging target region 12 is determined by an angle of view designated by a user of the imaging apparatus 10 (hereinafter referred to as “user”). In the example shown in FIG. 1, the imaging target region 12 includes persons 12A to 12D, a road 12E, and the like. The imaging apparatus 10 is an example of “imaging apparatus” according to the present disclosed technology.

In the example shown in FIG. 1, the imaging apparatus 10 is a lens-interchangeable digital camera for consumer use. The imaging apparatus 10 comprises an imaging apparatus body 14 and an interchangeable lens 16. The interchangeable lens 16 is interchangeably mounted on the imaging apparatus body 14. Here, the lens-interchangeable digital camera is described as an example of the imaging apparatus 10, but this is merely an example. A lens-fixed digital camera may be used.

Here, the digital camera for consumer use as an example of the imaging apparatus 10 is exemplified, but this is merely an example. The present disclosed technology is established even in a case where the imaging apparatus 10 is a digital camera for industrial use. Further, the present disclosed technology is also established even in a case where the imaging apparatus 10 is an imaging apparatus mounted on various electronic apparatuses, such as a drive recorder, a smart device, a wearable terminal, a cell observation device, an ophthalmic observation device, and a surgical microscope.

Further, the present disclosed technology is also established even in a case where the imaging apparatus 10 is an imaging apparatus mounted on various modalities, such as an endoscope apparatus, an ultrasound diagnostic apparatus, an X-ray imaging apparatus, a computed tomography (CT) apparatus, and a magnetic resonance imaging (MRI) apparatus.

The imaging apparatus 10 is provided with a user interface (UI) system device 18. The UI system device 18 receives an operation to the imaging apparatus 10 or presents (for example, displays) various types of information to the user.

In the example shown in FIG. 1, the UI system device 18 includes a release button 20, a dial 22, a touch panel display 24, and an instruction key 26 that receives various instructions.

The release button 20 functions as an imaging preparation instruction unit and an imaging instruction unit, and provides imaging preparation instructions (for example, instructions of auto focus (AF) and auto exposure (AE)) and an imaging instruction to the imaging apparatus 10.

The dial 22 is operated in a case where an operation mode or the like is set. In the imaging apparatus 10, the dial 22 is operated to selectively set various operation modes. The operation mode includes the operation mode of an imaging system. Examples of the operation mode of the imaging system include a still image capturing mode and a moving image capturing mode.

The touch panel display 24 comprises a display 28 and a touch panel 30. An example of the display 28 includes a liquid crystal display and an electroluminescent (EL) display. The display 28 displays a live view image, a still image, a moving image, a menu screen, and the like. In the example shown in FIG. 1, the display 28 displays the live view image.

The imaging apparatus 10 images the imaging target region 12 at a frame rate for moving image to generate moving image data 32 indicating an image in which the imaging target region 12 is shown. The moving image data 32 includes a frame group 34. The frame group 34 consists of a plurality of frames 36 (that is, a plurality of pieces of image data arranged in time series). A type of the frame 36 is, for example, visible light image data obtained by imaging the imaging target region 12 in a visible light range. However, the type of the frame 36 is not limited thereto, and may be invisible light image data obtained by performing the imaging in a wavelength range other than the visible light range.

The moving image data 32 is an example of “moving image data” according to the present disclosed technology. Further, the frame group 34 is an example of “frame group” according to the present disclosed technology. Further, the frame 36 is an example of “frame” according to the present disclosed technology.

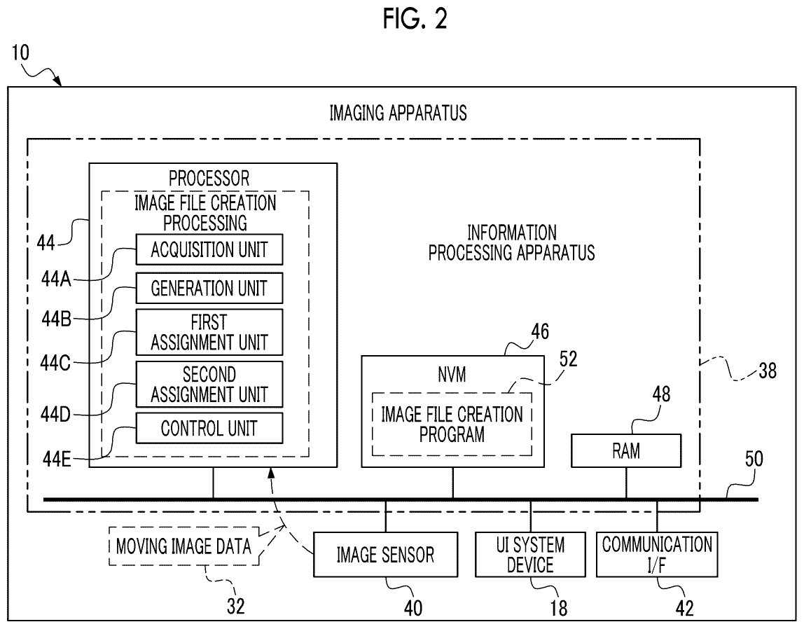

As shown in FIG. 2 as an example, the imaging apparatus 10 comprises the UI system device 18, an information processing apparatus 38, an image sensor 40, and a communication interface (I/F) 42. The information processing apparatus 38 is an example of “information processing apparatus” according to the present disclosed technology.

The information processing apparatus 38 comprises a processor 44, a non-volatile memory (NVM) 46, and a random access memory (RAM) 48. The processor 44, the NVM 46, and the RAM 48 are connected to a bus 50. The processor 44 is an example of “processor” according to the present disclosed technology.

The processor 44 is a processing device including a digital signal processor (DSP), a central processing unit (CPU), and a graphics processing unit (GPU), and the DSP and the GPU operate under control of the CPU and are responsible for execution of processing related to the image. Here, the processing device including the DSP, the CPU, and the GPU is described as an example of the processor 44, but this is merely an example. The processor 44 may be one or more CPUs and DSPs that integrate GPU functions, may be one or more CPUs and DSPs that do not integrate the GPU functions, or may be provided with a tensor processing unit (TPU).

The NVM 46 is a non-volatile storage device that stores various programs, various parameters, and the like. An example of the NVM 46 includes a flash memory (for example, electrically erasable and programmable read only memory (EEPROM)).

The RAM 48 is a memory in which information is temporarily stored and is used as a work memory by the processor 44. An example of the RAM 48 includes a dynamic random access memory (DRAM) or a static random access memory (SRAM).

The image sensor 40 is connected to the bus 50. An example of the image sensor 40 includes a complementary metal oxide semiconductor (CMOS) image sensor. The image sensor 40 images the imaging target region 12 (refer to FIG. 1) under the control of the processor 44 to generate the moving image data 32.

Here, an example of the image sensor 40 includes the CMOS image sensor, but this is merely an example. The image sensor 40 may be another type of image sensor such as a charge coupled device (CCD) image sensor.

The image sensor 40 is an example of “sensor” according to the present disclosed technology.

The UI system device 18 is connected to the bus 50. The UI system device 18 receives the instruction from the user and outputs a signal indicating the received instruction to the processor 44. Further, the UI system device 18 presents various types of information to the user under the control of the processor 44. The presentation of the various types of information is realized by, for example, the display 28 (refer to FIG. 1) and a speaker (not shown).

The communication I/F 42 includes a communication processor, an antenna, and the like, and is connected to the bus 50. A communication standard applied to the communication I/F 42 is, for example, a wireless communication standard including a 5th generation mobile communication system (5G), Wi-Fi (registered trademark), or Bluetooth (registered trademark).

Meanwhile, the imaging apparatus 10 performs the imaging in the moving image capturing mode to generate a moving image file including the moving image data 32. There is a need to reproduce the moving image file to check a content of the moving image data 32 included in the moving image file. In this case, for example, in order to understand what kind of configuration the entire moving image data 32 has, it is necessary to reproduce most of the moving image data 32. A reproduction time is required as the number of sheets of the frames 36 included in the moving image data 32 is larger. Further, for example, in order to understand what kind of configuration a part of the plurality of frames 36 included in the moving image data 32 has, it is necessary to reproduce the corresponding part of the plurality of frames 36. Thus, the reproduction time is also required. It takes time to specify, from the frame group 34, the corresponding part of the plurality of frames 36, in addition to the required reproduction time.

In consideration of such circumstances, in the imaging apparatus 10, the processor 44 performs image file creation processing, as shown in FIG. 2 as an example. In the image file creation processing, an image file is created. The image file created by performing the image file creation processing has accessory information (for example, metadata) described below. In the imaging apparatus 10, the NVM 46 stores an image file creation program 52. The processor 44 reads out the image file creation program 52 from the NVM 46 and executes the readout image file creation program 52 on the RAM 48 to perform the image file creation processing. The image file creation processing is realized by the processor 44 operating as an acquisition unit 44A, a generation unit 44B, a first assignment unit 44C, a second assignment unit 44D, and a control unit 44E in accordance with the image file creation program 52 executed on the RAM 48.

The processing performed by the acquisition unit 44A is an example of “acquisition step” according to the present disclosed technology. Further, the processing performed by the first assignment unit 44C is an example of “first assignment step” according to the present disclosed technology. Further, the processing performed by the second assignment unit 44D is an example of “second assignment step” according to the present disclosed technology.

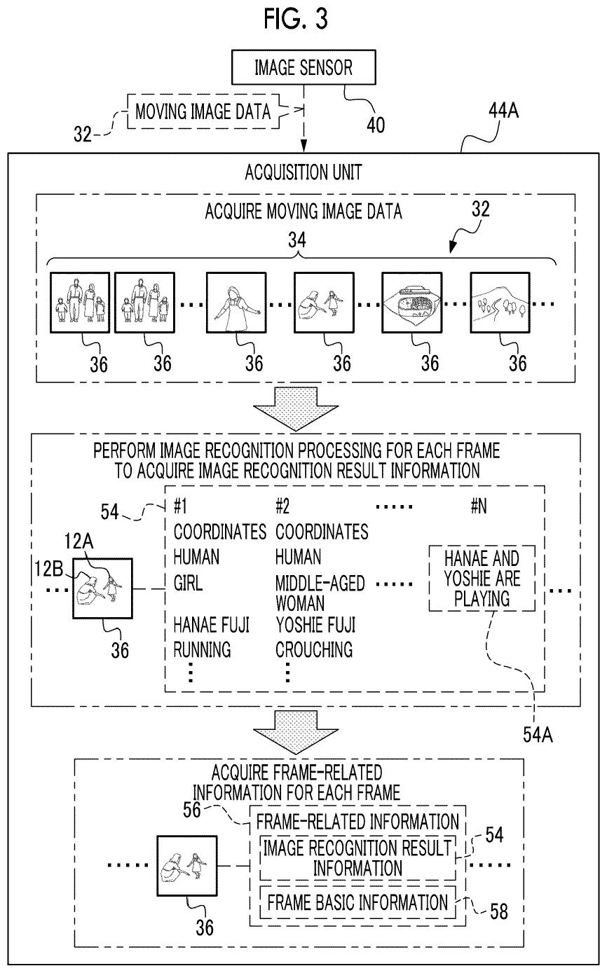

As shown in FIG. 3 as an example, the acquisition unit 44A acquires the moving image data 32 from the image sensor 40. The acquisition unit 44A performs image recognition processing of an artificial intelligence (AI) type for each frame 36, which is included in the frame group 34 of the moving image data 32, to acquire image recognition result information 54 recorded as the metadata. The image recognition result information 54 indicates a result obtained by performing the image recognition processing of the AI type.

In the example shown in FIG. 3, the image recognition result information 54 includes information related to the persons 12A and 12B, which are shown in the frame 36, and scene information 54A. The image recognition result information 54 is assigned with an identifier (“#1” to “#N” in the example shown in FIG. 3) for each subject recognized by the image recognition processing. The subject recognized by the image recognition processing is not limited to a single subject, and also includes a combination of a plurality of subjects.

The example shown in FIG. 3 shows, as the information related to the person 12A, coordinates that can specify a position of the person 12A in the frame 36 (that is, two-dimensional coordinates), a type of the person 12A (“human”, “girl”, and “name (name “Hanae Fuji” in the example shown in FIG. 3)” in the example shown in FIG. 3), and an attribute of the person 12A (“running” in the example shown in FIG. 3).

Further, the example shown in FIG. 3 shows, as the information related to the person 12B, coordinates that can specify a position of the person 12B in the frame 36 (that is, two-dimensional coordinates), a type of the person 12B (“human”, “middle-aged woman”, and “name (name “Yoshie Fuji” in the example shown in FIG. 3)” in the example shown in FIG. 3), and an attribute of the person 12B (“crouching” in the example shown in FIG. 3).

The scene information 54A relates to a scene specified from the frame 36. The scene specified from the frame 36 is, for example, an aspect of a combination of the person 12A and the person 12B. The example shown in FIG. 3 shows, as the scene information 54A, information “Hanae and Yoshie are playing”. Here, an aspect of the combination of the person 12A and the person 12B is exemplified as the scene specified from the frame 36, but this is merely an example. For example, an aspect of one subject shown in the frame 36 (for example, combination of the persons 12A and 12B or the persons 12A to 12D and landscape) may be applied as the scene. The scene obtained is changed depending on a specification of the image recognition processing of the AI type or a result obtained by performing the image recognition processing of the AI type.

Here, the image recognition processing of the AI type is exemplified, but the present disclosed technology is not limited thereto. The image recognition processing of a template matching type may be applied, or the image recognition processing of the AI type and the image recognition processing of the template matching type may be used in combination. Further, one or more labels may be assigned to the subject shown in the frame 36 in accordance with the instruction provided to the imaging apparatus 10 from the outside (for example, instruction received by UI system device 18). Further, one or more assigned labels may be used as the image recognition result information 54. The label is, for example, the coordinates that can specify the position of the subject in the frame 36, the type of the subject, and the attribute of the subject.

The acquisition unit 44A acquires frame-related information 56 for each frame 36 included in the frame group 34 of the moving image data 32. The frame-related information 56 includes the image recognition result information 54 corresponding to the frame 36 and frame basic information 58 corresponding to the frame 36. The frame-related information 56 is an example of “information related to one frame included in frame group” according to the present disclosed technology.

The frame basic information 58 includes a frame identifier, model information, lens information, date and time information, imaging condition information, and the like. The frame identifier can identify the frame 36. The model information indicates a model of the imaging apparatus body 14. The lens information indicates a type and specification of the interchangeable lens 16 (refer to FIG. 1). The date and time information is a date and time (for example, time point expressed in year, month, day, hour, minute, and second) at which the frame 36 corresponding to the frame-related information 56 is obtained. The imaging condition information indicates an imaging condition (for example, F number, shutter speed, sensitivity of image sensor 40, 35 mm equivalent focal length, and ON/OFF of camera-shake correction) set for the imaging apparatus 10.

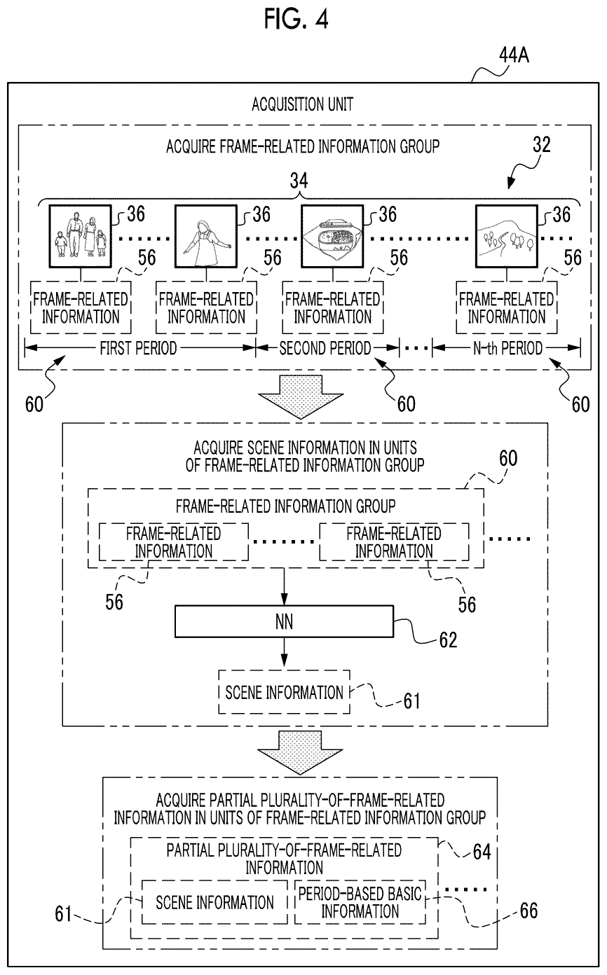

As shown in FIG. 4 as an example, the acquisition unit 44A acquires all pieces of the frame-related information 56 associated with the frame group 34 of the moving image data 32 in a divided manner into a plurality of frame-related information groups 60. The plurality of frame-related information groups 60 are obtained by dividing all pieces of the frame-related information 56 in a plurality of designated periods (first period to N-th period in the example shown in FIG. 4). That is, the frame-related information group 60 is a set of a plurality of pieces of frame-related information 56. The plurality of periods may be determined in accordance with the instruction received by the UI system device 18. Further, the plurality of periods may be determined in accordance with an algorithm set in advance. In this case, for example, all pieces of the frame-related information 56 associated with the frame group 34 may be divided at a time interval uniquely determined in accordance with the number of sheets of all the frames 36 included in the frame group 34.

The acquisition unit 44A acquires scene information 61 from the frame-related information group 60 and the frame group 34 corresponding to the frame-related information group 60. The scene information 61 relates to a scene specified from the plurality of frames 36, which are associated with the frame-related information group 60. Examples of the scene specified from the plurality of frames 36 include a lunch in a picnic, a dish in a picnic, and fishing in a picnic. The scene information 61 is expressed by, for example, a text that can specify a scene, a mark (for example, pictogram) that can specify a scene, a thumbnail image (for example, thumbnail still image or a thumbnail moving image) that can specify a scene, a combination of the text and the mark, a combination of the text and the thumbnail image, a combination of the thumbnail image and the mark, or a combination of the text, the mark, and the thumbnail image.

The scene information 61 is obtained by using a neural network (NN) 62 that is a type of a mathematical model. For the NN 62, learning using a plurality of pieces of supervised data including information corresponding to the plurality of frame-related information groups 60 and correct answer data (here, as an example, information related to a plurality of scenes) is performed, and scores related to various scenes are output from the NN 62. The acquisition unit 44A inputs the frame-related information group 60 to the NN 62. The acquisition unit 44A specifies the scene with reference to the score output from the NN 62 by inputting the frame-related information group 60 to the NN 62, and acquires the information related to the specified scene as the scene information 61.

Here, the embodiment example has been described in which the scene specified from the plurality of frames 36, which are associated with the frame-related information group 60, is specified by using the NN 62, but this is merely an example. For example, the user may apply a scene determined for each period in accordance with the instruction provided to the imaging apparatus 10 via the UI system device 18 or a device indirectly or directly connected to the imaging apparatus 10.

The acquisition unit 44A acquires partial plurality-of-frame-related information 64 in units of the frame-related information group 60. The partial plurality-of-frame-related information 64 includes the scene information 61, which is specified from the corresponding frame-related information group 60, and period-based basic information 66. The partial plurality-of-frame-related information 64 is an example of “information related to a part of the plurality of frames of the frame group” according to the present disclosed technology.

The period-based basic information 66 includes the frame identifier, the model information, the lens information, the time information, the imaging condition information, and the like. The frame identifier included in the period-based basic information 66 can identify the frame 36 that contributes to obtaining the scene information 61 at a certain level or higher. An example of the frame 36 that contributes to obtaining the scene information 61 at the certain level or higher includes the frame 36 associated with the frame-related information 56 whose score output from the NN 62 is a certain value or more. The model information included in the period-based basic information 66 is statistically obtained from the plurality of pieces of frame-related information 56 included in the frame-related information group 60 (for example, model information most included in the plurality of pieces of frame-related information 56). The lens information included in the period-based basic information 66 is statistically obtained from the plurality of pieces of frame-related information 56 included in the frame-related information group 60 (for example, lens information most included in the plurality of pieces of frame-related information 56).

The time information included in the period-based basic information 66 includes two pieces of date and time information included in head frame-related information 56 and tail frame-related information 56 of the frame-related information group 60. Further, the time information included in the period-based basic information 66 may be two frame identifiers included in the head frame-related information 56 and the tail frame-related information 56 of the frame-related information group 60. Further, the time information included in the period-based basic information 66 may indicate a time slot calculated from the date and time information included in the head frame-related information 56 of the frame-related information group 60 and the date and time information included in the tail frame-related information 56 of the frame-related information group 60.

The imaging condition information included in the period-based basic information 66 is statistically obtained from the plurality of pieces of frame-related information 56 included in the frame-related information group 60 (for example, imaging condition information most included in the plurality of pieces of frame-related information 56).

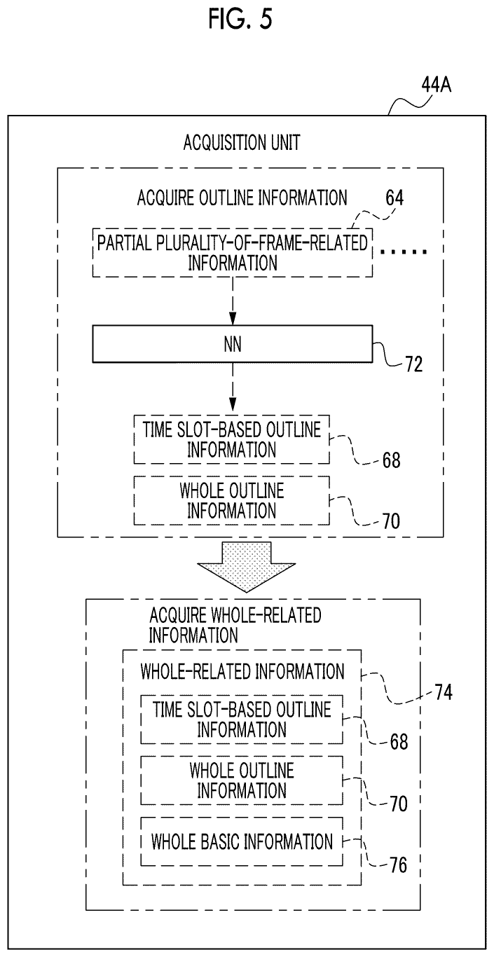

As shown in FIG. 5 as an example, the acquisition unit 44A acquires outline information indicating an outline of the moving image data 32. The outline refers to a title expressing a content shown in the moving image data 32, a sentence expressing a content shown in the moving image data 32, a mark expressing a content shown in the moving image data 32, a thumbnail image expressing a content shown in the moving image data 32, or the like.

In the example shown in FIG. 5, examples of the outline information include time slot-based outline information 68 and whole outline information 70. The time slot-based outline information 68 indicates the outline by time slot in the moving image data 32. The outline by time slot is, for example, an outline of each piece of moving image data obtained by equally dividing the moving image data 32, or an outline of each piece of moving image data obtained by dividing the moving image data 32 in the first period to the N-th period shown in FIG. 4. The whole outline information 70 indicates the outline of the entire moving image data 32. The time slot-based outline information 68 and the whole outline information 70 are specified from, for example, a plurality of pieces of partial plurality-of-frame-related information 64. In the following, in a case where the time slot-based outline information 68 and the whole outline information 70 do not need to be distinguished from each other, the time slot-based outline information 68 and the overall outline information 70 are referred to as “outline information” without reference numerals.

The outline information is obtained by using an NN 72. For the NN 72, learning using a plurality of pieces of supervised data including information corresponding to the plurality of pieces of partial plurality-of-frame-related information 64 and correct answer data (here, as an example, information related to a plurality of outlines) is performed, and scores related to various outlines are output from the NN 72. The acquisition unit 44A inputs one or more pieces of partial plurality-of-frame-related information 64 to the NN 72. The acquisition unit 44A specifies the outline with reference to the score output from the NN 72 by inputting one or more pieces of partial plurality-of-frame-related information 64 to the NN 72, and acquires information related to the specified outline as the outline information. The outline information is an example of “information related to configuration of moving image data” according to the present disclosed technology.

Here, the embodiment example has been described in which the learning using the plurality of pieces of supervised data including the information corresponding to the plurality of pieces of partial plurality-of-frame-related information 64 and the correct answer data is performed for the NN 72, but this is merely an example. The plurality of pieces of supervised data may include information corresponding to the plurality of pieces of frame-related information 56.

Further, here, the embodiment example has been described in which the outline is specified by using the NN 62, but this is merely an example. For example, the user may apply an outline determined in accordance with the instruction provided to the imaging apparatus 10 via the UI system device 18 or a device indirectly or directly connected to the imaging apparatus 10.

Further, here, the outline information is exemplified, but this is merely an example. For example, information indicating the types of all the subjects shown in the moving image data 32, information indicating a geographical feature specified from the landscape shown in the moving image data 32, or information indicating a common subject shown in the moving image data 32 may be applied, instead of the outline information or together with the outline information. As described above, any information may be used as the information to be applied, instead of the outline information or together with the outline information, as long as the information relates to the configuration of the moving image data 32.

The acquisition unit 44A acquires whole-related information 74. The whole-related information 74 includes the time slot-based outline information 68, the whole outline information 70, and whole basic information 76.

The whole basic information 76 includes the frame identifier, the model information, the lens information, the time information, the imaging condition information, a moving image identifier, and the like.

The frame identifier included in the whole basic information 76 can identify the frame 36 that contributes to obtaining the outline information at a certain level or higher.

An example of the frame 36 that contributes to obtaining the outline information at the certain level or more includes the frame 36 associated with the partial plurality-of-frame-related information 64 whose score output from the NN 72 is a certain value or more. The model information included in the whole basic information 76 is statistically obtained from the plurality of pieces of partial plurality-of-frame-related information 64 (for example, model information most included in the plurality of pieces of partial plurality-of-frame-related information 64). The lens information included in the whole basic information 76 is statistically obtained from the plurality of pieces of partial plurality-of-frame-related information 64 (for example, lens information most included in the plurality of pieces of partial plurality-of-frame-related information 64). The time information included in the whole basic information 76 is a start time point and an end condition of the moving image data 32. Further, the time information included in the whole basic information 76 may be a time required for reproducing the moving image data 32.

The imaging condition information included in the whole basic information 76 is statistically obtained from the plurality of pieces of partial plurality-of-frame-related information 64 (for example, imaging condition information most included in the plurality of pieces of partial plurality-of-frame-related information 64). The moving image identifier included in the whole basic information 76 is uniquely assigned to the entire moving image data 32. The whole basic information 76 may include a bit rate of the moving image data 32, a codec used for encoding and decoding of the moving image data 32, or the like, as another piece of basic information related to the entire moving image data 32.

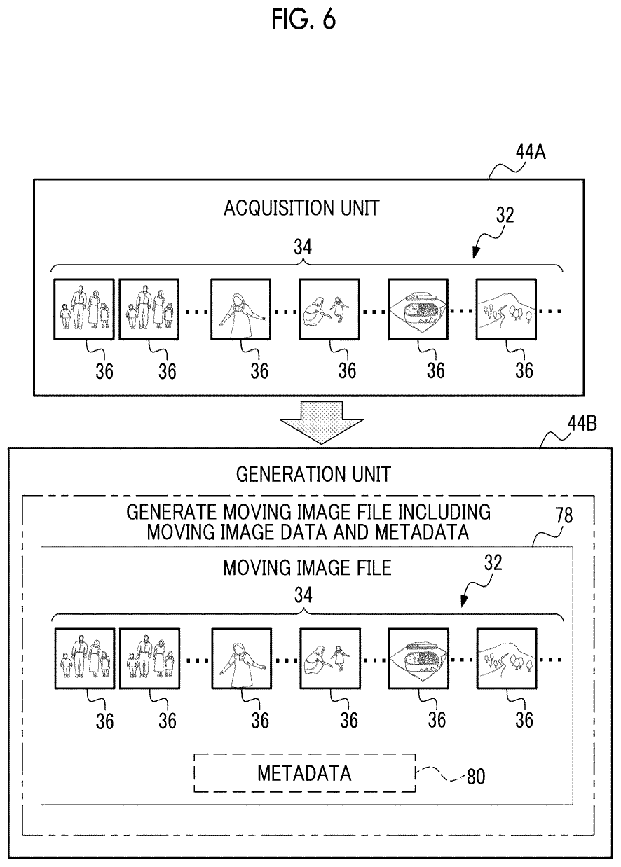

As shown in FIG. 6 as an example, the generation unit 44B generates a moving image file 78. The moving image file 78 includes metadata 80. The metadata 80 is data related to the moving image data 32 (that is, data accessory to the moving image data 32). Here, the moving image file is an example of “image file” according to the present disclosed technology. The metadata 80 is an example of “accessory information” according to the present disclosed technology.

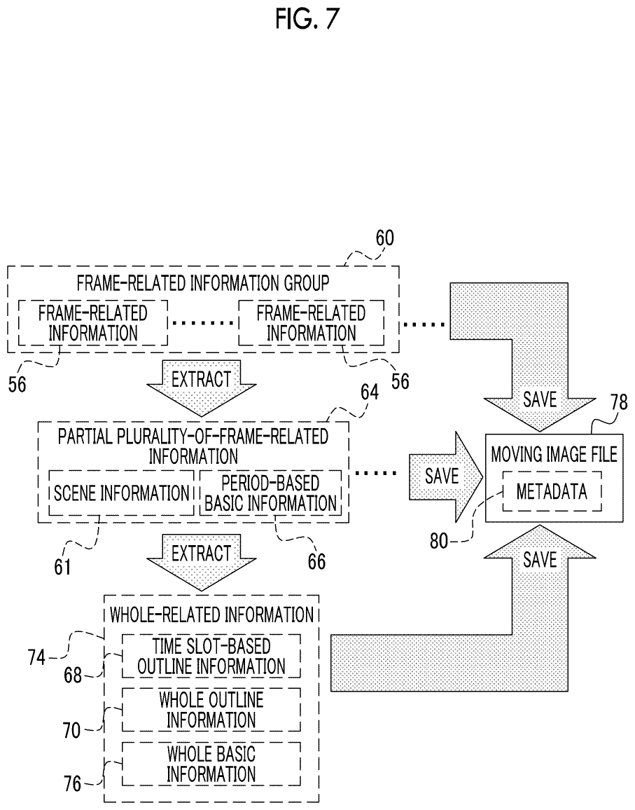

To summarize the contents described above, for example, as shown in FIG. 7, the plurality of pieces of frame-related information 56 are saved (recorded) in the moving image file 78 as the metadata 80. Further, the plurality of pieces of partial plurality-of-frame-related information 64 (that is, information including the scene information 61 and the period-based basic information 66), which are extracted from the plurality of pieces of frame-related information 56, are also saved in the moving image file 78 as the metadata 80. Furthermore, the whole-related information 74 (that is, information including the time slot-based outline information 68, the whole outline information 70, and the whole basic information 76), which is extracted from the plurality of pieces of partial plurality-of-frame-related information 64, is also saved in the moving image file 78 as metadata 80.

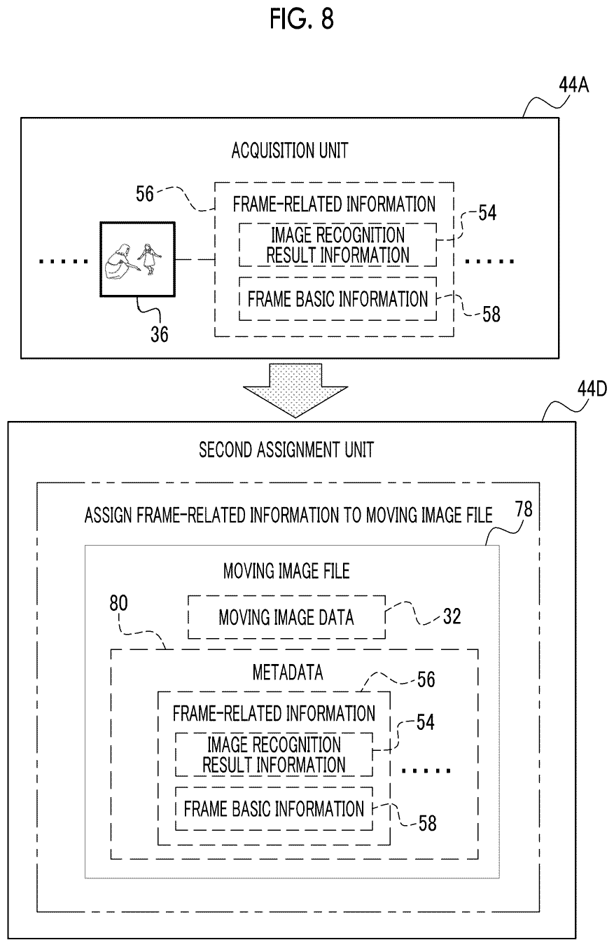

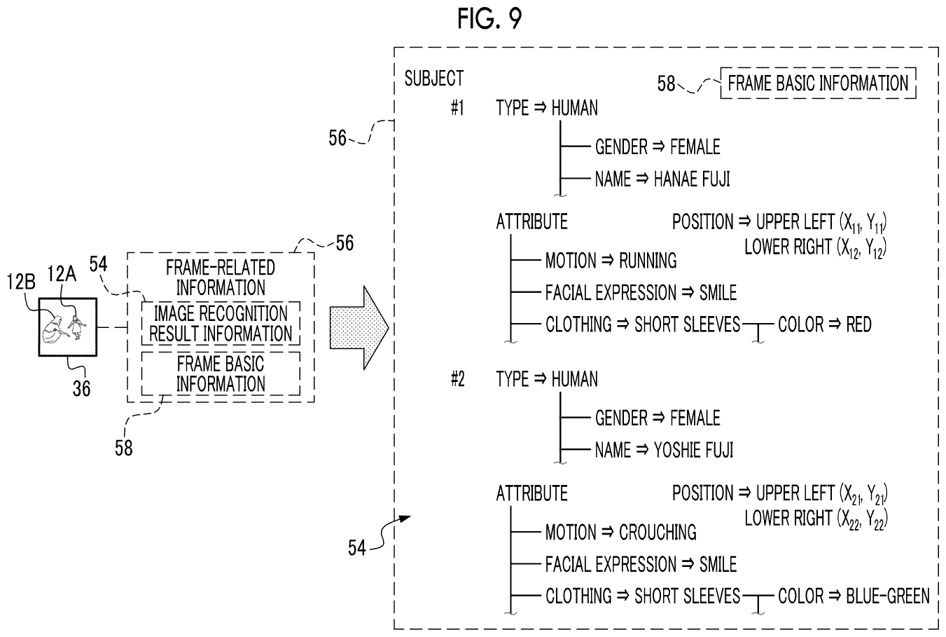

As shown in FIG. 8 as an example, the second assignment unit 44D includes the frame-related information 56, which is acquired for each frame 36 by the acquisition unit 44A, in the metadata 80 to assign the frame-related information 56 to the moving image file 78. In this case, for example, as shown in FIG. 9, the image recognition result information 54 included in the frame-related information 56, which is assigned to the moving image file 78, is classified into a plurality of categories. For example, a subject identifier (“#1” and “#2” in the example shown in FIG. 9) that is unique to each subject (for example, each of the person 12A, the person 12B, and a combination of the persons 12A and 12B) shown in the frame 36 is assigned. The plurality of categories, such as a type category, an attribute category, and a position category, are assigned to the subject identifier. In the example shown in FIG. 9, the plurality of categories are provided for each of the type category and the attribute category in a hierarchical manner. In a lower hierarchy, a category of a lower-level concept or derived concept of an upper hierarchy is provided. Further, in the example shown in FIG. 9, information related to the person 12A is assigned to “#1”, and information related to the person 12B is assigned to “#2”.

The type category indicates a type of the subject. In the example shown in FIG. 9, “human” is assigned to the type category as the type of the subject. In a lower hierarchy than the type category, the gender category and the name category are provided. The gender category indicates gender, and the name category indicates a name of the subject (for example, a general noun or a proper noun).

The attribute category indicates an attribute of the subject. In the example shown in FIG. 9, a motion category, a facial expression category, and a clothing category are provided, and a color category is provided as a lower hierarchy of the clothing category. The motion category indicates a motion of the subject. The expression category indicates a facial expression of the subject. The clothing category indicates a type of clothing worn by the subject. The color category indicates a color of clothing worn by the subject.

The position category indicates a position of the subject in the frame 36. In the example shown in FIG. 9, coordinate information that can specify the position of the person 12A is assigned to “#1”, and coordinates that can specify the position of the person 12B is assigned to “#2”. The coordinate information is, for example, two-dimensional coordinates of an upper left corner of a bounding box (that is, square frame surrounding the subject shown in the frame 36), which is obtained by the image recognition processing of the AI type, and two-dimensional coordinates of a lower right corner of the bounding box.

In the moving image file 78, various types of information included in the frame basic information 58 may be classified into categories in a hierarchical manner, in the same manner as the image recognition result information 54.

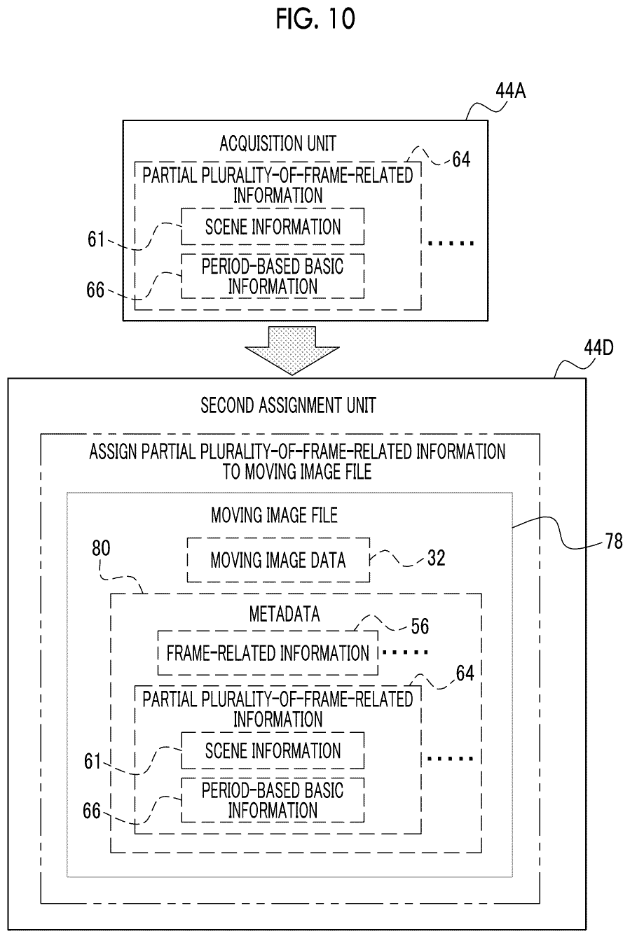

As shown in FIG. 10 as an example, the second assignment unit 44D includes the plurality of pieces of partial plurality-of-frame-related information 64, which are acquired by the acquisition unit 44A, in the metadata 80 to assign the plurality of pieces of partial plurality-of-frame-related information 64 to the moving image file 78. The plurality of pieces of frame-related information 56 and the plurality of pieces of partial plurality-of-frame-related information 64, which are included in the metadata 80, are examples of “second accessory information” according to the present disclosed technology.

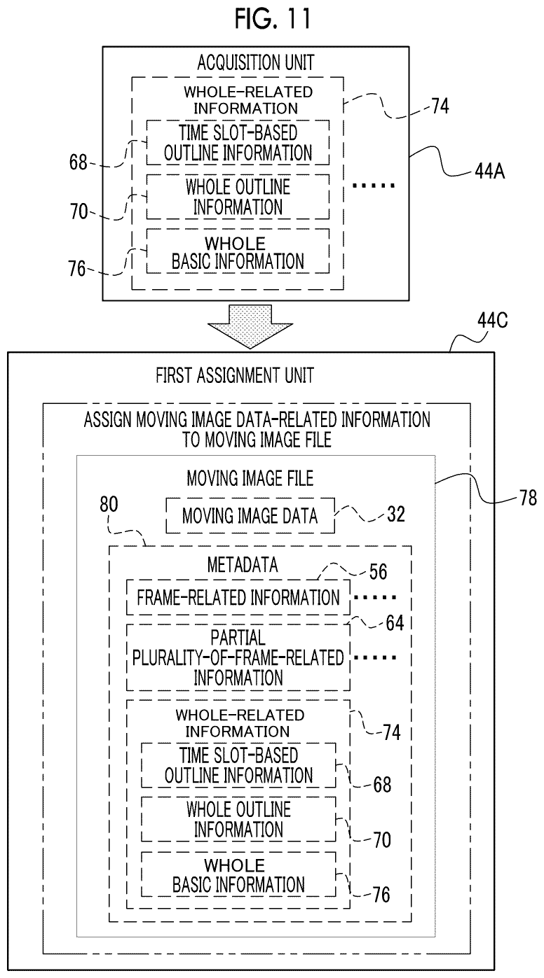

As shown in FIG. 11 as an example, the first assignment unit 44C includes the whole-related information 74, which is acquired by the acquisition unit 44A, in the metadata 80 to assign the whole-related information 74 to the moving image file 78. The whole-related information 74 included in the metadata 80 is an example of “first accessory information” and “information related to all the frames included in the frame group” according to the present disclosed technology.

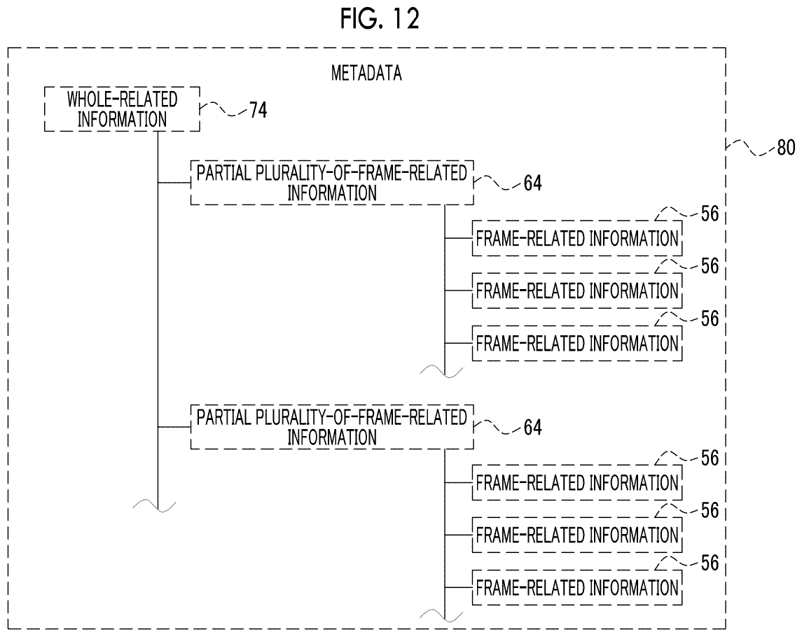

As shown in FIG. 12 as an example, the metadata 80 has a hierarchical structure. The hierarchical structure has an upper layer, a middle layer, and a lower layer. The upper layer stores information related to the entire frame group 34. The middle layer stores information related to the plurality of frames 36 obtained by dividing the frame group 34 by period shown in FIG. 4. The lower layer stores information related to the frame 36. In the example shown in FIG. 12, the whole-related information 74 is stored in the upper layer, the partial plurality-of-frame-related information 64 are stored in the middle layer, and the frame-related information 56 is stored in the lower layer. That is, the plurality of pieces of partial plurality-of-frame-related information 64 are present in a lower layer of the whole-related information 74, and the plurality of pieces of frame-related information 56 are present in a lower layer of the partial plurality-of-frame-related information 64. Since the metadata 80 is hierarchized in this manner, the user or the like can easily specify the information in the metadata 80.

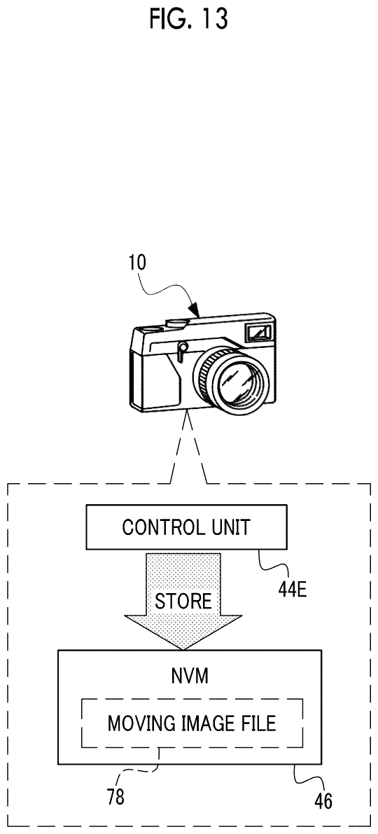

As shown in FIG. 13 as an example, in the imaging apparatus 10, the control unit 44E stores the moving image file 78 obtained as described above in the NVM 46.

In the example shown in FIG. 13, the embodiment example has been described in which the moving image file 78 is stored in the NVM 46, but this is merely an example. The moving image file 78 may be stored in one or more storage media other than the NVM 46. The storage medium may be used by being directly or indirectly connected to the imaging apparatus 10 by a wired method, a wireless method, or the like. Examples of the storage medium include a digital versatile disc (DVD), a universal serial bus (USB) memory, a solid state drive (SSD), a hard disk drive (HDD), and a magnetic tape drive.

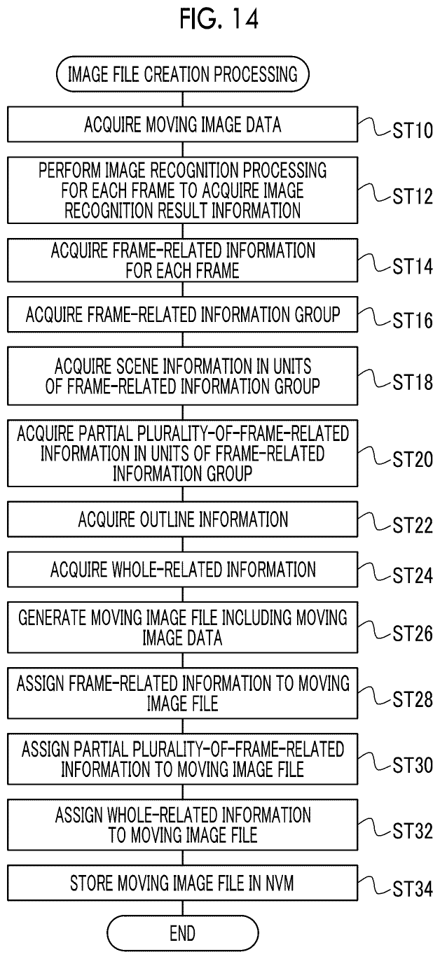

Next, an action of the imaging apparatus 10 will be described with reference to FIG. 14. A flow of processing indicated by a flowchart shown in FIG. 14 is an example of “generation method” according to the present disclosed technology.

In the image file creation processing shown in FIG. 14, first, in step ST10, the acquisition unit 44A acquires the moving image data 32 from the image sensor 40 (refer to FIG. 3). The processing of step ST10 is executed, and then the image file creation processing proceeds to step ST12.

In step ST12, the acquisition unit 44A performs the image recognition processing of the AI type for each frame 36, which is included in the frame group 34 of the moving image data 32 acquired in step ST10, to acquire the image recognition result information 54 (refer to FIG. 3). The processing of step ST12 is executed, and then the image file creation processing proceeds to step ST14.

In step ST14, the acquisition unit 44A acquires the frame-related information 56 for each frame 36, which is included in the frame group 34 of the moving image data 32 acquired in step ST10 (refer to FIG. 3). The frame-related information 56 includes the image recognition result information 54 and the frame basic information 58 (refer to FIG. 3). The processing of step ST14 is executed, and then the image file creation processing proceeds to step ST16.

In step ST16, the acquisition unit 44A acquires the plurality of frame-related information groups 60 from all pieces of the frame-related information 56, which are associated with the frame group 34 of the moving image data 32 acquired in step ST10 (refer to FIG. 4). The processing of step ST16 is executed, and then the image file creation processing proceeds to step ST18.

In step ST18, the acquisition unit 44A acquires the scene information 61 in units of the frame-related information group 60 acquired in step ST16 (refer to FIG. 4). The scene information 61 is obtained by using the score output from the NN 62 by inputting the frame-related information group 60 to the NN 62. The processing of step ST18 is executed, and then the image file creation processing proceeds to step ST20.

In step ST20, the acquisition unit 44A acquires the partial plurality-of-frame-related information 64 in units of the frame-related information group 60 acquired in step ST16 (refer to FIG. 4). The partial plurality-of-frame-related information 64 includes the scene information 61 and the period-based basic information 66 (refer to FIG. 4). The processing of step ST20 is executed, and then the image file creation processing proceeds to step ST22.

In step ST22, the acquisition unit 44A acquires the outline information (refer to FIG. 5). The outline information is obtained by using the score output from the NN 72 by inputting the partial plurality-of-frame-related information 64 acquired in step ST20 to the NN 72. The processing of step ST22 is executed, and then the image file creation processing proceeds to step ST24.

In step ST24, the acquisition unit 44A acquires the whole-related information 74 (refer to FIG. 5). The whole-related information 74 includes the outline information and the whole basic information 76 (refer to FIG. 5). The processing of step ST22 is executed, and then the image file creation processing proceeds to step ST26.

In step ST26, the generation unit 44B generates the moving image file 78 including the moving image data 32 acquired in step ST10 and the metadata 80 (refer to FIG. 6). The processing of step ST26 is executed, and then the image file creation processing proceeds to step ST28.

In step ST28, the second assignment unit 44D includes the frame-related information 56 acquired in step ST14 in the metadata 80 to assign the frame-related information 56 to the moving image file 78 (refer to FIG. 8). The processing of step ST28 is executed, and then the image file creation processing proceeds to step ST30.

In step ST30, the second assignment unit 44D includes the partial plurality-of-frame-related information 64 acquired in step ST20 in the metadata 80 to assign the partial plurality-of-frame-related information 64 to the moving image file 78 (refer to FIG. 10). The processing of step ST30 is executed, and then the image file creation processing proceeds to step ST32.

In step ST32, the first assignment unit 44C includes the whole-related information 74 acquired in step ST24 in the metadata 80 to assign the whole-related information 74 to the moving image file 78 (refer to FIG. 11). The processing of step ST32 is executed, and then the image file creation processing proceeds to step ST34.

In step ST34, the control unit 44E stores the moving image file 78, which is obtained by executing the pieces of processing of steps ST10 to ST32, in the NVM 46 (refer to FIG. 13). The processing of step ST34 is executed, and then the image file creation processing ends.

As described above, in the imaging apparatus 10, with the acquisition of the moving image data 32, the moving image file 78 including the moving image data 32 is generated. In the related art, in order for the user to understand the content of the moving image data 32, the moving image data 32 is needed to be reproduced. However, in the imaging apparatus 10, the whole-related information 74 is acquired as the information related to all the frames 36, which are included in the frame group 34 of the moving image data 32, and is assigned to the moving image file 78. Therefore, the user or the like (for example, the user or various devices) can understand the contents of all the frames 36 included in the frame group 34, with reference to the whole-related information 74, without reproducing the moving image data 32. Further, in the imaging apparatus 10, the partial plurality-of-frame-related information 64 is acquired as the information related to the part of the plurality of frames 36 included in the frame group 34 of the moving image data 32 and is assigned to the moving image file 78. Therefore, the user can understand the content of the part of the plurality of frames 36 included in the frame group 34, with reference to the partial plurality-of-frame-related information 64, without reproducing the moving image data 32. As described above, with the imaging apparatus 10 according to the present embodiment, the user or the like can understand the content of the moving image data 32 without reproducing the moving image data 32.

Further, in the imaging apparatus 10, the frame-related information 56 is acquired as the information related to one frame 36, which is included in the frame group 34 of the moving image data 32, and is assigned to the moving image file 78. Therefore, the user or the like can understand the content of one frame 36 included in the frame group 34, with reference to the frame-related information 56, without reproducing the moving image data 32. Accordingly, it is possible to determine whether or not the frame 36 is an important frame 36 in units of the frame 36.

Further, in the imaging apparatus 10, the frame-related information 56 is assigned to the moving image file 78. The frame-related information 56 includes the image recognition result information 54. The image recognition result information 54 includes the scene information 54A. The scene information 54A relates to the scene specified from the frame 36. Therefore, the user or the like can understand the scene specified from the frame 36, with reference to the scene information 54A included in the image recognition result information 54 of the frame-related information 56, without reproducing the moving image data 32. Accordingly, it is possible to determine whether or not the frame 36 is an important frame 36 in units of the frame 36.

Further, in the imaging apparatus 10, the partial plurality-of-frame-related information 64 is assigned to the moving image file 78. The partial plurality-of-frame-related information 64 includes the scene information 61. The scene information 61 relates to a scene specified from the part of the plurality of frames 36 (that is, the plurality of frames 36 associated with the frame-related information group 60) included in the frame group 34 of the moving image data 32. Therefore, the user or the like can understand the scene specified from the part of the plurality of frames 36 included in the frame group 34 of the moving image data 32, with reference to the scene information 61 included in the partial plurality-of-frame-related information 64, without reproducing the moving image data 32. Accordingly, it is possible to determine whether or not the frame 36 is an important frame 36 in units of the plurality of frames 36.

### First Modification Example

In the above embodiment, the embodiment example has been described in which the frame-related information 56 includes the image recognition result information 54 and the frame basic information 58, but the present disclosed technology is not limited thereto. For example, the frame-related information 56 and the partial plurality-of-frame-related information 64 may include information related to a change of the subject in the moving image data 32.

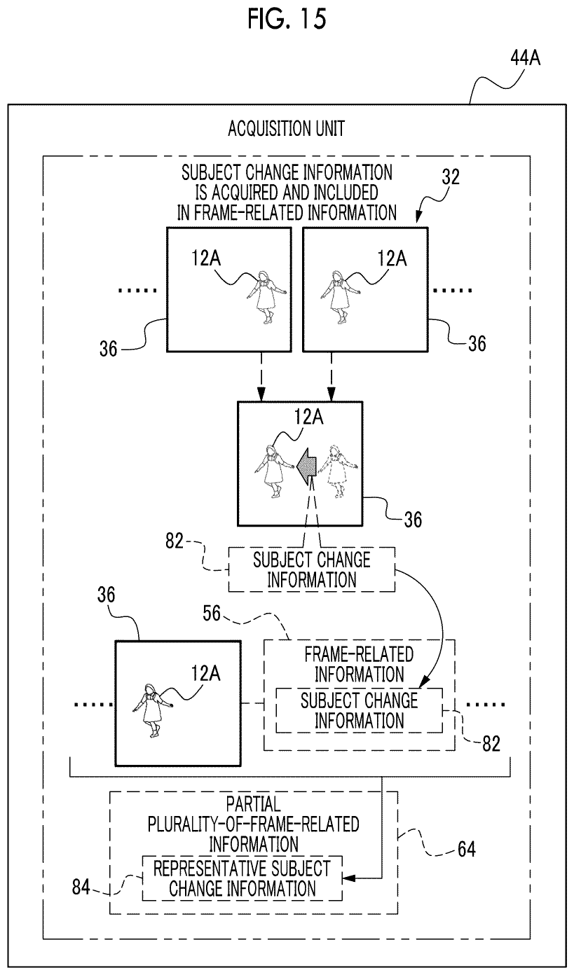

In this case, for example, as shown in FIG. 15, the acquisition unit 44A acquires subject change information 82 and includes the subject change information 82 in the frame-related information 56. The subject change information 82 relates to a change of the person 12A shown in the plurality of frames 36 of the moving image data 32. An example of the information related to the change of the person 12A includes a movement vector of the person 12A shown in the plurality of frames 36 preceding and following each other in time (two frames 36 adjacent to each other in time in the example shown in FIG. 15), or information based on the movement vector. The information based on the movement vector refers to, for example, information indicating a movement direction of the person 12A or information indicating a movement amount of the person 12A. Further, another example of the information related to the change of the person 12A includes information related to a change in the facial expression of the person 12A shown in the plurality of frames 36 preceding and following each other in time, information related to a change in an optical element (brightness or color tone) of the person 12A, or information related to a change in a size of the person 12A in the frame 36.

Further, the acquisition unit 44A acquires representative subject change information 84, and includes the acquired representative subject change information 84 in the partial plurality-of-frame-related information 64. The representative subject change information 84 included in the partial plurality-of-frame-related information 64 is obtained from one or more pieces of subject change information 82 included in one or more pieces of frame-related information 56, which correspond to the partial plurality-of-frame-related information 64. For example, main subject change information 82 satisfying a designated condition, among the one or more pieces of subject change information 82, is set as the representative subject change information 84. An example of the subject change information 82 satisfying the designated condition includes the subject change information 82 of the person 12A having a largest size or the subject change information 82 in which a degree of change of the person 12A is the largest (for example, subject change information 82 in which the movement vector is the largest). Further, in the example shown in FIG. 15, an example of the representative subject change information 84 includes information “person is walking to the left”.

In the present first modification example, the subject change information 82 and the representative subject change information 84 are examples of “change information” according to the present disclosed technology.

As described above, in the imaging apparatus 10 according to the present first modification example, the frame-related information 56 includes the subject change information 82. Therefore, the user or the like can understand the change of the subject (here, as an example, the person 12A) in units of the frame 36, with reference to the subject change information 82 in the frame-related information 56, without reproducing the moving image data 32. Accordingly, it is possible to determine whether or not the frame 36 is an important frame 36 in units of the frame 36.

Further, in the imaging apparatus 10 according to the present first modification example, the partial plurality-of-frame-related information 64 includes the representative subject change information 84. Therefore, the user or the like can understand the change of the subject in units of the part of the plurality of frames 36 included in the frame group 34, with reference to the representative subject change information 84 in the partial plurality-of-frame-related information 64, without reproducing the moving image data 32. Accordingly, it is possible to determine whether or not the frame 36 is an important frame 36 in units of the plurality of frames 36.

### Second Modification Example

In the first modification example, the embodiment example has been described in which the frame-related information 56 includes the subject change information 82, and the embodiment example has been described in which the partial plurality-of-frame-related information 64 includes the representative subject change information 84. However, the present disclosed technology is not limited thereto. For example, the frame-related information 56 and the partial plurality-of-frame-related information 64 may include information indicating a change in a position or an orientation of the imaging apparatus 10.

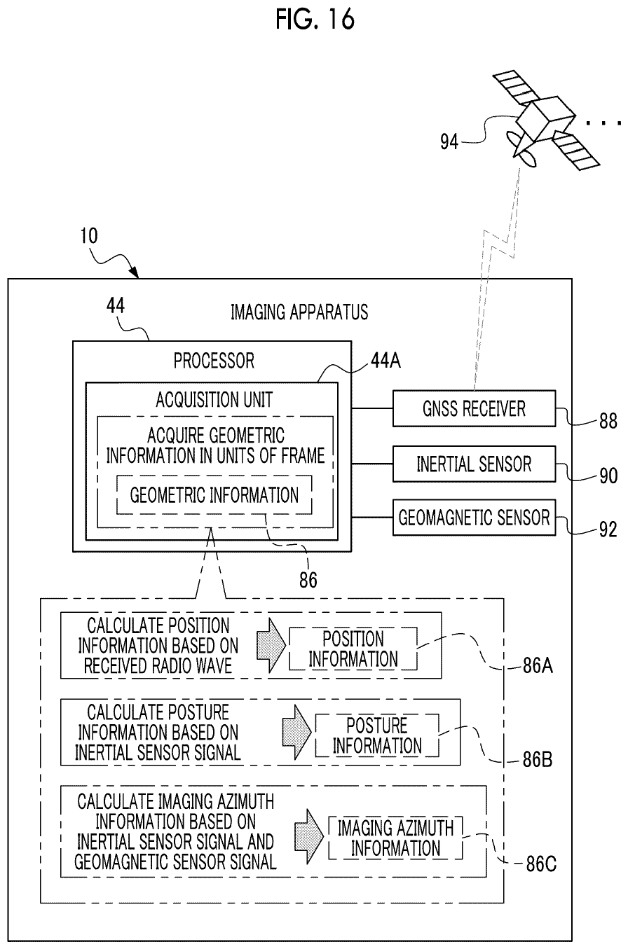

In this case, for example, as shown in FIG. 16, the acquisition unit 44A acquires geometric information 86 in units of the frame 36. The geometric information 86 relates to the imaging apparatus 10. The geometric information refers to, for example, a position of the imaging apparatus 10, a posture of the imaging apparatus 10, and an imaging azimuth of the imaging apparatus 10. Examples of the geometric information 86 include position information 86A, posture information 86B, and imaging azimuth information 86C. The position information 86A relates to the position of the imaging apparatus 10. The posture information 86B relates to the posture of the imaging apparatus 10. The imaging azimuth information 86C is information in which the imaging direction (that is, orientation of optical axis) of the imaging apparatus 10 is expressed by an azimuth.

The imaging apparatus 10 is provided with a global navigation satellite system (GNSS) receiver 88, an inertial sensor 90, and a geomagnetic sensor 92. The GNSS receiver 88, the inertial sensor 90, and the geomagnetic sensor 92 are connected to the processor 44. The GNSS receiver 88 receives radio waves transmitted from a plurality of satellites 94. The inertial sensor 90 measures physical quantities (for example, angular velocity and acceleration) indicating a three-dimensional inertial movement of the imaging apparatus 10 and outputs an inertial sensor signal indicating a measurement result. The geomagnetic sensor 92 detects geomagnetism and outputs a geomagnetic sensor signal indicating a detection result.

The acquisition unit 44A calculates, as the position information 86A, a latitude, a longitude, and an altitude that can specify a current position of the imaging apparatus 10 based on the radio wave received by the GNSS receiver 88. Further, the acquisition unit 44A calculates the posture information 86B (for example, information defined by yaw angle, roll angle, and pitch angle) based on the inertial sensor signal input from the inertial sensor 90. Further, the acquisition unit 44A calculates the imaging azimuth information 86C based on the inertial sensor signal input from the inertial sensor 90 and the geomagnetic sensor signal input from the geomagnetic sensor 92. Further, the acquisition unit 44A calculates an imaging posture (whether long-side direction of camera faces vertically or horizontally) of the imaging apparatus 10 from the information of the inertial sensor 90.

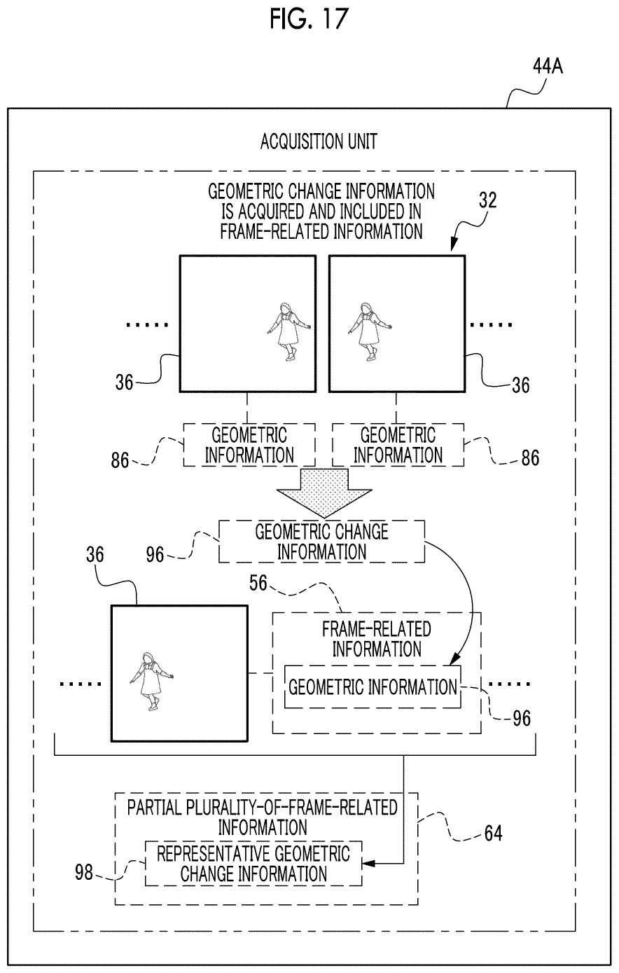

As shown in FIG. 17 as an example, the acquisition unit 44A acquires geometric change information 96 and includes the geometric change information 96 in the frame-related information 56. The geometric change information 96 relates to a change in the geometric information 86 between the plurality of frames 36 (two frames 36 adjacent to each other in time in the example shown in FIG. 17). For example, the geometric change information 96 includes an absolute value of a difference in the position information 86A between the plurality of frames 36, an absolute value of a difference in the posture information 86B between the plurality of frames 36, and an absolute value of a difference in the imaging azimuth information 86C. Here, the absolute value of the differences is exemplified, but a ratio may be applied instead of the absolute value of the differences, and any index may be used as long as a degree of difference can be specified. In the following, the absolute value of the differences is also exemplified, but the same can be said.

The acquisition unit 44A acquires representative geometric change information 98, and includes the acquired representative geometric change information 98 in the partial plurality-of-frame-related information 64. The representative geometric change information 98 is obtained from one or more pieces of geometric change information 96 included in one or more pieces of frame-related information 56 corresponding to the partial plurality-of-frame-related information 64. For example, the geometric change information 96 satisfying a designated condition, among the one or more pieces of geometric change information 96, is set as the representative geometric change information 98.

An example of a first example of the geometric change information 96 satisfying the designated condition includes the geometric change information 96 having a largest degree of change in the geometric information 86, the geometric change information 96 having a smallest degree of change in the geometric information 86, or the geometric change information 96 having information corresponding to a median value of the plurality of pieces of geometric change information 96.

An example of a second example of the geometric change information 96 satisfying the designated condition includes the geometric change information 96 in which the absolute value of the difference in the position information 86A between the plurality of frames 36 is the largest, the geometric change information 96 in which the absolute value of the difference in the position information 86A between the plurality of frames 36 is the smallest, or the geometric change information 96 in which the absolute value of the difference in the position information 86A between the plurality of frames 36 is a median value.

An example of a third example of the geometric change information 96 satisfying the designated condition includes the geometric change information 96 in which the absolute value of the difference in the posture information 86B between the plurality of frames 36 is the largest, the geometric change information 96 in which the absolute value of the difference in the posture information 86B between the plurality of frames 36 is the smallest, or the geometric change information 96 in which the absolute value of the difference in the posture information 86B between the plurality of frames 36 is a median value.

An example of a fourth example of the geometric change information 96 satisfying the designated condition includes the geometric change information 96 in which the absolute value of the difference in the imaging azimuth information 86C between the plurality of frames 36 is the largest, the geometric change information 96 in which the absolute value of the difference in the imaging azimuth information 86C between the plurality of frames 36 is the smallest, or the geometric change information 96 in which the absolute value of the difference in the imaging azimuth information 86C between the plurality of frames 36 is a median value.

In the present second modification example, the geometric change information 96 and the representative geometric change information 98 are examples of “change information” according to the present disclosed technology.

As described above, in the imaging apparatus 10 according to the present second modification example, the frame-related information 56 includes the geometric change information 96. Therefore, the user or the like can understand the change in the position or the orientation of the imaging apparatus 10 in units of the frame 36, with reference to the geometric change information 96 in the frame-related information 56, without reproducing the moving image data 32. Accordingly, it is possible to determine whether or not the frame 36 is an important frame 36 in units of the frame 36.

Further, in the imaging apparatus 10 according to the present second modification example, the partial plurality-of-frame-related information 64 includes the representative geometric change information 98. Therefore, the user or the like can understand the change in the position or the orientation of the imaging apparatus 10 in units of the part of the plurality of frames 36 included in the frame group 34, with reference to the representative geometric change information 98 in the partial plurality-of-frame-related information 64, without reproducing the moving image data 32. Accordingly, it is possible to determine whether or not the frame 36 is an important frame 36 in units of the plurality of frames 36.

### Third Modification Example

In the second modification example, the embodiment example has been described in which the frame-related information 56 includes the geometric change information 96, and the embodiment example has been described in which the partial plurality-of-frame-related information 64 includes the representative geometric change information 98. However, the present disclosed technology is not limited thereto. For example, the frame-related information 56 and the partial plurality-of-frame-related information 64 may include information indicating a change in the angle of view of the imaging apparatus 10.

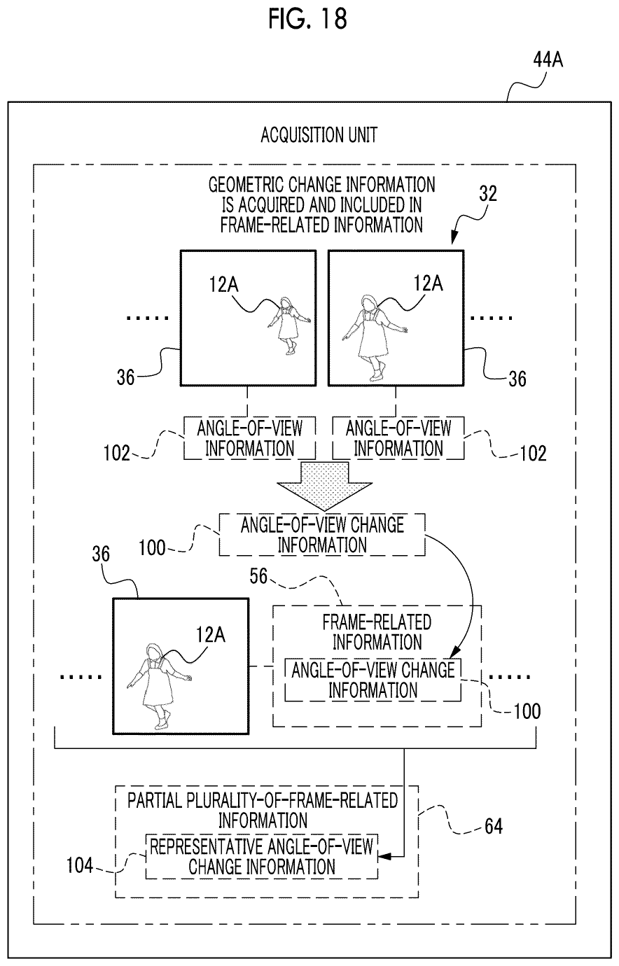

In this case, for example, as shown in FIG. 18, the acquisition unit 44A acquires angle-of-view change information 100 and includes the angle-of-view change information 100 in the frame-related information 56. Angle-of-view information 102 is associated with the frame 36. The angle-of-view information 102 relates to the angle of view set in the imaging apparatus 10 (for example, focal length in accordance with change in zoom magnification). An example of the angle-of-view change information 100 includes an absolute value of a difference in the angle-of-view information 102 between the plurality of frames 36 (two frames 36 adjacent to each other in time in the example shown in FIG. 18).

Further, the acquisition unit 44A acquires representative angle-of-view change information 104, and includes the acquired representative angle-of-view change information 104 in the partial plurality-of-frame-related information 64. The representative angle-of-view change information 104 is obtained from one or more pieces of angle-of-view change information 100 included in one or more pieces of frame-related information 56 corresponding to the partial plurality-of-frame-related information 64. For example, the angle-of-view change information 100 satisfying a designated condition, among the one or more pieces of angle-of-view change information 100, is set as the representative angle-of-view change information 104.

An example of the angle-of-view change information 100 satisfying the designated condition includes the angle-of-view change information 100 in which a degree of change of the angle-of-view information 102 is the largest, the angle-of-view change information 100 in which the degree of change of the angle-of-view information 102 is the smallest, or the angle-of-view change information 100 that corresponds to a median value of the plurality of pieces of angle-of-view change information 100.

In the present third modification example, the angle-of-view change information 100 and the representative angle-of-view change information 104 are examples of “change information” according to the present disclosed technology. Accordingly, it is possible to determine whether or not the frame 36 is an important frame 36 in units of the frame 36.

As described above, in the imaging apparatus 10 according to the present third modification example, the frame-related information 56 includes the angle-of-view change information 100. Therefore, the user or the like can understand the change in the angle of view of the imaging apparatus 10 in units of the frame 36, with reference to the angle-of-view change information 100 in the frame-related information 56, without reproducing the moving image data 32.

Further, in the imaging apparatus 10 according to the present third modification example, the partial plurality-of-frame-related information 64 includes the representative angle-of-view change information 104. Therefore, the user or the like can understand the change in the angle of view of the imaging apparatus 10 in units of the part of the plurality of frames 36 included in the frame group 34, with reference to the representative angle-of-view change information 104 in the partial plurality-of-frame-related information 64, without reproducing the moving image data 32. Accordingly, it is possible to determine whether or not the frame 36 is an important frame 36 in units of the plurality of frames 36.

### Fourth Modification Example

In the third modification example, the embodiment example has been described in which the frame-related information 56 includes the angle-of-view change information 100, and the embodiment example has been described in which the partial plurality-of-frame-related information 64 includes the representative angle-of-view change information 104. However, the present disclosed technology is not limited thereto. For example, in a case where a tracking mode for tracking the subject is set for the imaging apparatus 10, the frame-related information 56 and the partial plurality-of-frame-related information 64 may include information related to tracking of the subject.

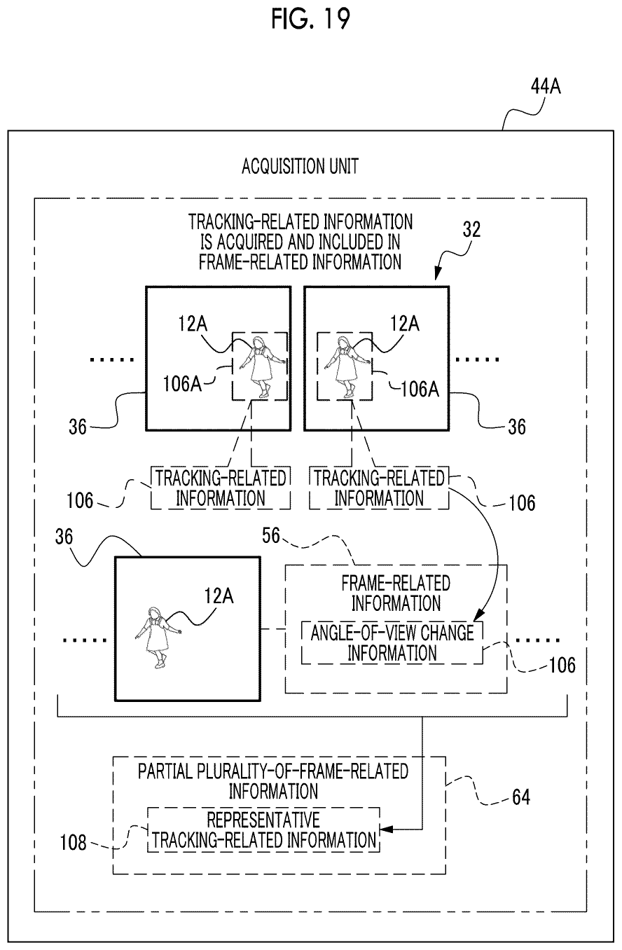

In this case, for example, as shown in FIG. 19, the acquisition unit 44A acquires tracking-related information 106 in units of the frame 36, and includes the acquired tracking-related information 106 in the corresponding frame-related information 56. The tracking-related information 106 is, for example, coordinates for specifying a position of a tracking frame 106A (for example, AF frame) that tracks the person 12A in the frame 36. Examples of the coordinates for specifying the position of the tracking frame 106A include, in a case where an upper left corner of the frame 36 is set as an origin, two-dimensional coordinates of an upper left corner of the tracking frame 106A and two-dimensional coordinates of an upper right corner of the tracking frame 106A.

Here, the coordinates for specifying the position of the tracking frame 106A are exemplified as the tracking-related information 106, but the present disclosed technology is not limited thereto. For example, the tracking-related information 106 may include information indicating that the tracking mode is set, or may include information indicating a feature of the subject to be tracked (for example, type or attribute of subject). As described above, the tracking-related information 106 may be any information as long as the information relates to the tracking of the subject.

The acquisition unit 44A acquires representative tracking-related information 108, and includes the acquired representative tracking-related information 108 in the partial plurality-of-frame-related information 64. The representative tracking-related information 108 is obtained from one or more pieces of tracking-related information 106 included in one or more pieces of frame-related information 56 corresponding to the partial plurality-of-frame-related information 64. For example, the tracking-related information 106 satisfying a designated condition, among the one or more tracking-related information 106, is set as the representative tracking-related information 108.

An example of the tracking-related information 106 satisfying the designated condition includes the tracking-related information 106 corresponding to the frame 36 having the tracking frame 106A that most overlaps with the tracking frame 106A of another frame 36.

In the present fourth modification example, the tracking-related information 106 and the representative tracking-related information 108 are examples of “information related to tracking subject” according to the present disclosed technology.

As described above, in the imaging apparatus 10 according to the present fourth modification example, the frame-related information 56 includes the tracking-related information 106. Therefore, the user or the like can understand the information related to the tracking of the subject in units of the frame 36, with reference to the tracking-related information 106 in the frame-related information 56, without reproducing the moving image data 32. Accordingly, it is possible to determine whether or not the frame 36 is an important frame 36 in units of the frame 36.

Further, in the imaging apparatus 10 according to the present fourth modification example, the partial plurality-of-frame-related information 64 includes the representative tracking-related information 108. Therefore, the user or the like can understand the information related to the tracking of the subject in units of the part of the plurality of frames 36 included in the frame group 34, with reference to the representative tracking-related information 108 in the partial plurality-of-frame-related information 64, without reproducing the moving image data 32. Accordingly, it is possible to determine whether or not the frame 36 is an important frame 36 in units of the plurality of frames 36.

### Fifth Modification Example

In the above-described fourth modification example, the embodiment example has been described in which the frame-related information 56 includes the tracking-related information 106, and the embodiment example has been described in which the partial plurality-of-frame-related information 64 includes the representative tracking-related information 108. However, the present disclosed technology is not limited thereto. For example, the frame-related information 56 and the partial plurality-of-frame-related information 64 may include information related to a movement of the imaging apparatus 10.

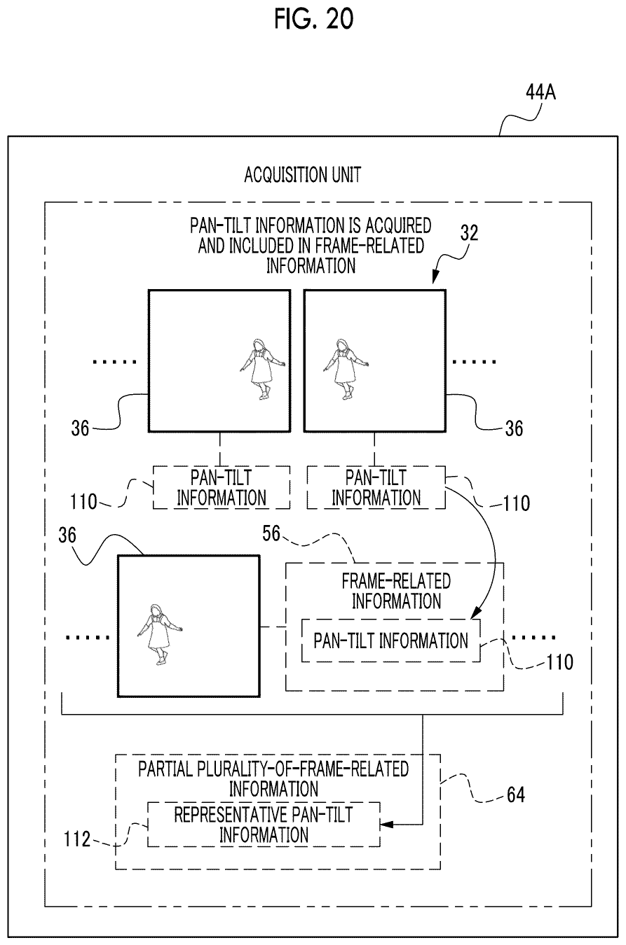

In this case, for example, as shown in FIG. 20, the acquisition unit 44A acquires pan-tilt information 110 in units of the frame 36, and includes the acquired pan-tilt information 110 in the corresponding frame-related information 56. The pan-tilt information 110 relates to information related to pan and information related to tilt in a situation in which the tracking mode is not set. For example, the pan-tilt information 110 includes information indicating a pan amount and information indicating a tilt amount between the plurality of frames 36 preceding and following each other in time (for example, two frames 36 adjacent to each other in time).

The pan amount and the tilt amount are calculated based on, for example, the inertial sensor signal output from the inertial sensor 90 (refer to FIG. 16). Further, here, the information related to the pan and the information related to the tilt in the situation in which the tracking mode is not set are exemplified as the pan-tilt information 110, but the present disclosed technology is not limited thereto. For example, the information related to the pan and the information related to the tilt in a situation in which the tracking mode is set may be used as the pan-tilt information 110.

Further, here, the pan amount and the tilt amount are exemplified, but the present disclosed technology is not limited thereto. Other physical quantities related to the pan and the tilt, such as a pan speed and a tilt speed, may be applied instead of the pan amount and the tilt amount or together with the pan amount and the tilt amount. Further, the pan and the tilt are merely an example. Information related to the movement (for example, movement amount and movement speed) in a case where the imaging apparatus 10 is moved in a horizontal direction and information related to the movement in a case where the imaging apparatus 10 is moved in a vertical direction may be applied instead of the pan-tilt information 110 or together with the pan-tilt information 110.

The acquisition unit 44A acquires representative pan-tilt information 112, and includes the acquired representative pan-tilt information 112 in the partial plurality-of-frame-related information 64. The representative pan-tilt information 112 is obtained from one or more pieces of pan-tilt information 110 included in the one or more pieces of frame-related information 56 corresponding to the partial plurality-of-frame-related information 64. For example, the pan-tilt information 110 satisfying a designated condition, among the one or more pieces of pan-tilt information 110, is set as the representative pan-tilt information 112. A first example of the pan-tilt information 110 satisfying the designated condition includes the pan-tilt information 110 in which the pan amount is the maximum or the minimum. A second example of the pan-tilt information 110 satisfying the designated condition includes the pan-tilt information 110 in which the tilt amount is the maximum or the minimum. A third example of the pan-tilt information 110 satisfying the designated condition includes the pan-tilt information 110 in which both the pan amount and the tilt amount are the maximum or the minimum.

In the present fifth modification example, the pan-tilt information 110 and the representative pan-tilt information 112 are examples of “information related to movement of imaging apparatus” according to the present disclosed technology.

As described above, in the imaging apparatus 10 according to the present fifth modification example, the frame-related information 56 includes the pan-tilt information 110. Therefore, the user or the like can understand the information related to the pan (for example, pan amount) and the information related to the tilt (for example, tilt amount) in units of the frame 36, with reference to the pan-tilt information 110 in the frame-related information 56, without reproducing the moving image data 32. Accordingly, it is possible to determine whether or not the frame 36 is an important frame 36 in units of the frame 36.

Further, in the imaging apparatus 10 according to the present fifth modification example, the partial plurality-of-frame-related information 64 includes the representative pan-tilt information 112. Therefore, the user or the like can understand the information related to the pan (for example, pan amount) and the information related to the tilt (for example, tilt amount) in units of the part of the plurality of frames 36 included in the frame group 34, with reference to the representative pan-tilt information 112 in the partial plurality-of-frame-related information 64, without reproducing the moving image data 32. Accordingly, it is possible to determine whether or not the frame 36 is an important frame 36 in units of the plurality of frames 36.

### Sixth Modification Example

In the fifth modification example, the embodiment example has been described in which the frame-related information 56 includes the pan-tilt information 110, and the embodiment example has been described in which the partial plurality-of-frame-related information 64 includes the representative pan-tilt information 112. However, the present disclosed technology is not limited thereto. For example, the frame-related information 56 and the partial plurality-of-frame-related information 64 may include information related to the sensor included in the imaging apparatus 10.

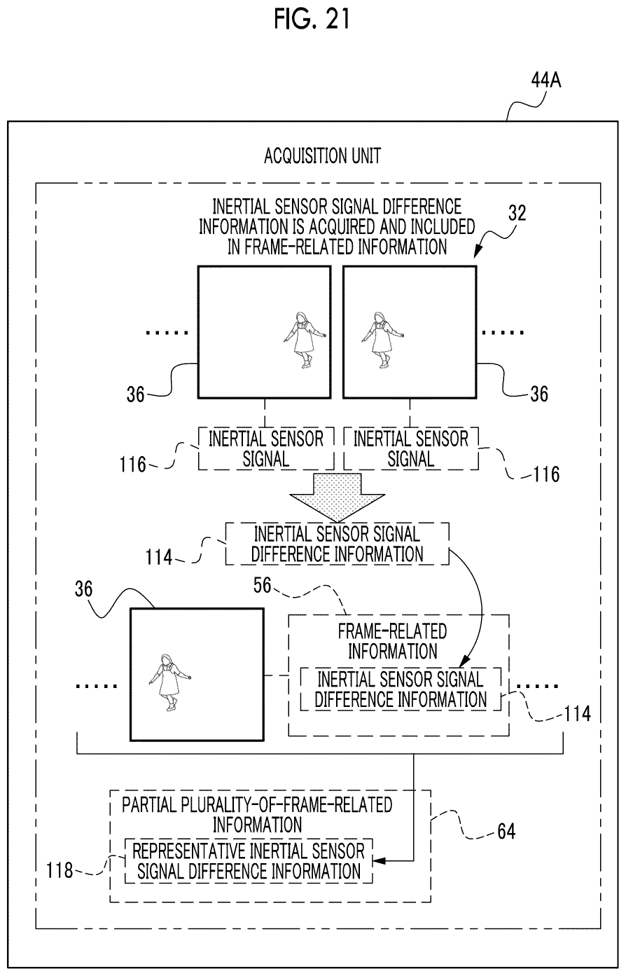

In this case, for example, as shown in FIG. 21, the acquisition unit 44A acquires inertial sensor signal difference information 114 in units of the frame 36, and includes the acquired inertial sensor signal difference information 114 in the corresponding frame-related information 56. The inertial sensor signal difference information 114 is an absolute value of a difference between inertial sensor signals 116 obtained in time series. The inertial sensor signal 116 is obtained from the inertial sensor 90 (refer to FIG. 16) in units of the frame 36. An example of the inertial sensor signal difference information 114 includes an absolute value of a difference between two inertial sensor signals 116 corresponding to two frames 36 adjacent to each other in time.

The acquisition unit 44A acquires representative inertial sensor signal difference information 118, and includes the acquired representative inertial sensor signal difference information 118 in the partial plurality-of-frame-related information 64. The representative inertial sensor signal difference information 118 is obtained from one or more pieces of inertial sensor signal difference information 114 included in one or more pieces of frame-related information 56 corresponding to the partial plurality-of-frame-related information 64. For example, the inertial sensor signal difference information 114 satisfying a designated condition, among the one or more pieces of inertial sensor signal difference information 114, is set as the representative inertial sensor signal difference information 118. An example of the inertial sensor signal difference information 114 satisfying the designated condition includes the inertial sensor signal difference information 114 in which the absolute value of the difference between the two inertial sensor signals 116 is the maximum or the minimum.

In the present sixth modification example, the inertial sensor signal difference information 114 and the representative inertial sensor signal difference information 118 are examples of “information related to first sensor” according to the present disclosed technology. Further, in the present sixth modification example, the inertial sensor 90 (refer to FIG. 16) is an example of “first sensor” according to the present disclosed technology.

As described above, in the imaging apparatus 10 according to the present sixth modification example, the frame-related information 56 includes the inertial sensor signal difference information 114. Therefore, the user or the like can understand the aspect of the imaging apparatus 10 (for example, posture or movement speed of imaging apparatus 10) in units of the frame 36, with reference to the inertial sensor signal difference information 114 in the frame-related information 56, without reproducing the moving image data 32. Accordingly, it is possible to determine whether or not the frame 36 is an important frame 36 in units of the frame 36.

Further, in the imaging apparatus 10 according to the present sixth modification example, the partial plurality-of-frame-related information 64 includes the representative inertial sensor signal difference information 118. Therefore, the user or the like can understand the aspect of the imaging apparatus 10 (for example, posture or movement speed of imaging apparatus 10) in units of the part of the plurality of frames 36 included in the frame group 34, with reference to the representative inertial sensor signal difference information 118 in the partial plurality-of-frame-related information 64, without reproducing the moving image data 32. Accordingly, it is possible to determine whether or not the frame 36 is an important frame 36 in units of the plurality of frames 36.

In the present sixth modification example, the embodiment example has been described in which the acquisition unit 44A acquires the inertial sensor signal difference information 114 and the representative inertial sensor signal difference information 118 as examples of “information related to first sensor” according to the present disclosed technology. However, this is merely an example. For example, the acquisition unit 44A may acquire magnetic field sensor signal difference information and representative magnetic field sensor signal difference information from the geomagnetic sensor signal output from the geomagnetic sensor 92 (refer to FIG. 16), in the same manner as the inertial sensor signal difference information 114 and the representative inertial sensor signal difference information 118. In this case, the frame-related information 56 may include the geomagnetic sensor signal difference information, and the partial plurality-of-frame-related information 64 may include the representative geomagnetic sensor signal difference information.

Further, in the present sixth modification example, the absolute value of the difference between the inertial sensor signals 116 is exemplified, but this is merely an example. For example, a ratio of one of the two inertial sensor signals 116 to the other may be employed, or information that can specify the degree of difference between the inertial sensor signals 116 may be employed.

Further, in the present sixth modification example, the inertial sensor 90 is exemplified as an example of “first sensor” according to the present disclosed technology, but this is merely an example. For example, the present disclosed technology is also established by handling, in a state where various sensors, such as a distance-measuring sensor and a temperature sensor, are mounted in the imaging apparatus 10, signals output from the various sensors, in the same manner as the inertial sensor signal difference information 114. For example, in a case where the imaging apparatus 10 is provided with the distance-measuring sensor, information based on a distance measurement result of the distance-measuring sensor (for example, information indicating distances at multiple positions or image obtained by reducing distance image) may be handled in the same manner as the inertial sensor signal difference information 114. Further, for example, in a case where the imaging apparatus 10 is provided with the temperature sensor, information based on a measurement result of the temperature sensor (for example, outside air temperature or image obtained by reducing thermal image) may be handled in the same manner as the inertial sensor signal difference information 114.

### Seventh Modification Example

In the sixth modification example, the embodiment example has been described in which the frame-related information 56 includes the inertial sensor signal difference information 114, and the embodiment example has been described in which the partial plurality-of-frame-related information 64 includes the representative inertial sensor signal difference information 118. However, the present disclosed technology is not limited thereto. For example, the frame-related information 56 and the partial plurality-of-frame-related information 64 may include information corresponding to a recording time at which the subject in the moving image data 32 is recorded.

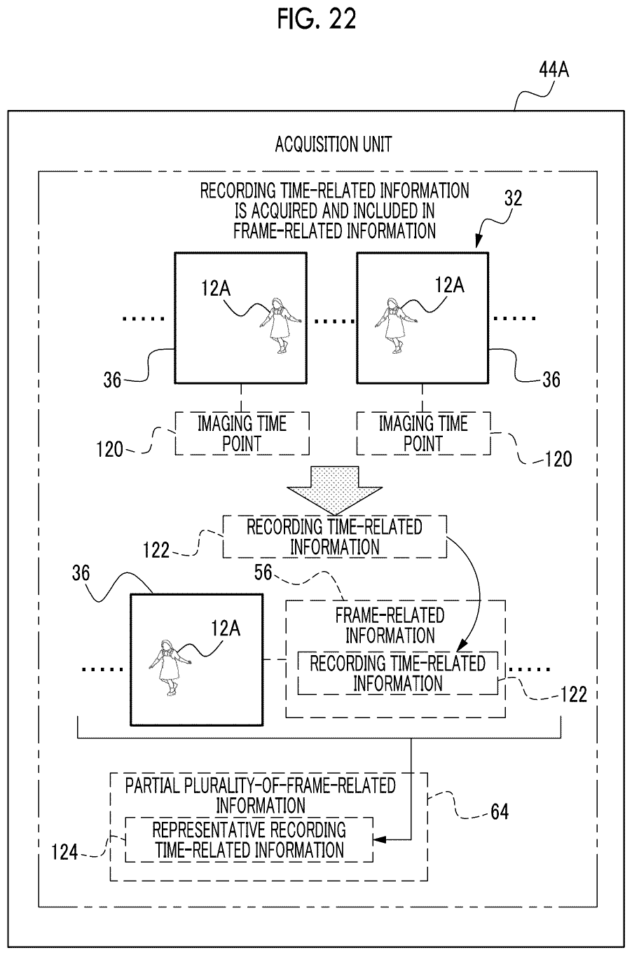

In this case, for example, as shown in FIG. 22, the acquisition unit 44A specifies the plurality of frames 36 in which the person 12A is continuously shown in the moving image data 32. The acquisition unit 44A acquires two imaging time points 120. The imaging time point 120 is a time point at which imaging for one frame is performed. One of the two imaging time points 120 is the imaging time point 120 corresponding to a head frame 36 among the plurality of frames 36 specified by the acquisition unit 44A, and the other is the imaging time point 120 corresponding to a tail frame 36 among the plurality of frames 36 specified by the acquisition unit 44A.

The acquisition unit 44A calculates recording time-related information 122 based on the two imaging time points 120. The recording time-related information 122 refers to, for example, information indicating an elapsed time between the two imaging time points 120 (that is, time during which the person 12A is continuously shown in moving image data 32). Here, the elapsed time between the two imaging time points 120 is described as the recording time-related information 122, but this is merely an example. The recording time-related information 122 may be the two imaging time points 120 itself or may be the frame identifier capable of identifying the two frames 36 corresponding to the two imaging time points 120.

The acquisition unit 44A includes the recording time-related information 122 in the plurality of pieces of frame-related information 56 corresponding to the plurality of frames 36 in which the person 12A is continuously shown in the moving image data 32. The recording time-related information 122 may be included in one or more pieces of designated frame-related information 56, among the plurality of pieces of frame-related information 56 corresponding to the plurality of frames 36 in which the person 12A is continuously shown in the moving image data 32. In this case, for example, the recording time-related information 122 may be included in the frame-related information 56 corresponding to the head frame 36 or the tail frame 36 of the plurality of frames 36 in which the person 12A is continuously shown in the moving image data 32.

The acquisition unit 44A acquires representative recording time-related information 124, and includes the acquired representative recording time-related information 124 in the partial plurality-of-frame-related information 64. The representative recording time-related information 124 is obtained from one or more pieces of recording time-related information 122 included in one or more pieces of frame-related information 56 corresponding to the partial plurality-of-frame-related information 64. For example, the recording time-related piece of information 122 satisfying a designated condition, among the one or more pieces of recording time-related information 122, is set as the representative recording time-related information 124. An example of the recording time-related information 122 satisfying the designated condition includes recording time-related information 122 in which the elapsed time between the two imaging time points 120 (that is, time during which person 12A is continuously shown in the moving image data 32) is the longest or the shortest.

In the present seventh modification example, the recording time-related information 122 and the representative recording time-related information 124 are examples of “information corresponding to recording time during which subject is recorded in moving image data” according to the present disclosed technology.

As described above, in the imaging apparatus 10 according to the present seventh modification example, the frame-related information 56 includes the recording time-related information 122. Therefore, the user or the like can understand the time during which the specific subject (for example, person 12A) is continuously shown in the moving image data 32 in units of the frame 36, with reference to the recording time-related information 122 in the frame-related information 56, without reproducing the moving image data 32. Accordingly, it is possible to determine whether or not the frame 36 is an important frame 36 in units of the frame 36.

Further, in the imaging apparatus 10 according to the present seventh modification example, the partial plurality-of-frame-related information 64 includes the representative recording time-related information 124. Therefore, the user or the like can understand the time during which the specific subject (for example, person 12A) is continuously shown in the moving image data 32 in units of the part of the plurality of frames 36 included in the frame group 34, with reference to the representative recording time-related information 124 in the partial plurality-of-frame-related information 64, without reproducing the moving image data 32. Accordingly, it is possible to determine whether or not the frame 36 is an important frame 36 in units of the plurality of frames 36.

### Eighth Modification Example

In the seventh modification example, the embodiment example has been described in which the frame-related information 56 includes the recording time-related information 122, and the embodiment example has been described in which the partial plurality-of-frame-related information 64 includes the representative recording time-related information 124. However, the present disclosed technology is not limited thereto. For example, the frame-related information 56 and the partial plurality-of-frame-related information 64 may include information related to the operation to the imaging apparatus 10.

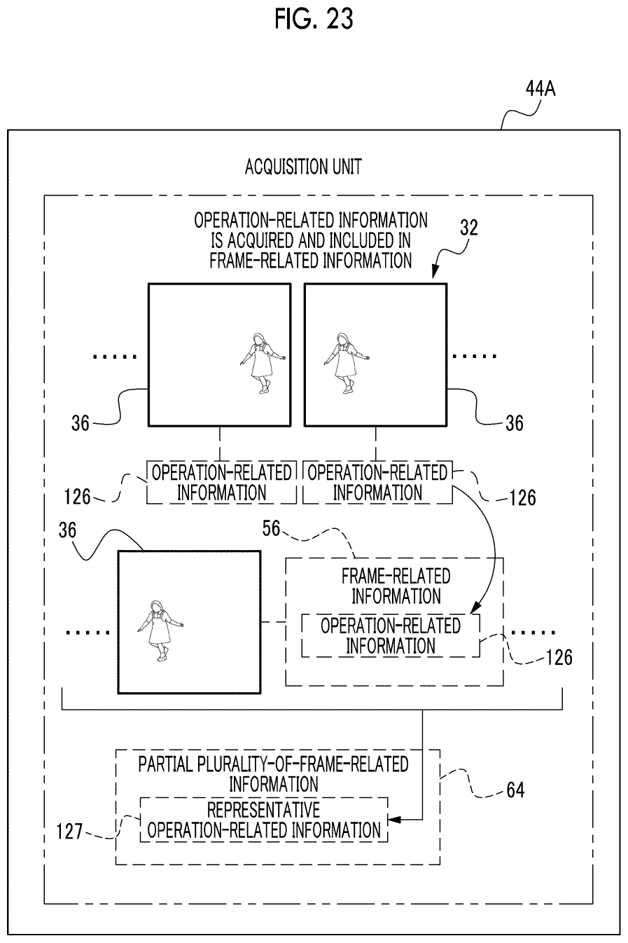

In this case, for example, as shown in FIG. 23, the acquisition unit 44A acquires operation-related information 126 in units of the frame 36, and includes the acquired operation-related information 126 in the corresponding frame-related information 56. The operation-related information 126 indicates an operation (for example, operation received by UI system device 18) performed on the imaging apparatus 10.

The acquisition unit 44A acquires representative operation-related information 127, and includes the acquired representative operation-related information 127 in the partial plurality-of-frame-related information 64. The representative operation-related information 127 is obtained from one or more pieces of operation-related information 126 included in one or more pieces of frame-related information 56 corresponding to the partial plurality-of-frame-related information 64. For example, the operation-related information 126 satisfying a designated condition, among the one or more pieces of operation-related information 126, is set as the representative operation-related information 127. An example of the operation-related information 126 satisfying the designated condition includes the operation-related information 126 indicating the most frequently performed operation or the least frequently performed operation, among the plurality of pieces of operation-related information 126 included in all the frame-related information 56 corresponding to the partial plurality-of-frame-related information 64.

In the present eighth modification example, the operation-related information 126 and the representative operation-related information 127 are examples of “information related to operation to imaging apparatus used for imaging to obtain moving image data” according to the present disclosed technology.

As described above, in the imaging apparatus 10 according to the present eighth modification example, the frame-related information 56 includes the operation-related information 126. Therefore, the user or the like can understand the operation performed on the imaging apparatus 10 in units of the frame 36, with reference to the operation-related information 126 in the frame-related information 56, without reproducing the moving image data 32. For example, for the frame 36 obtained while the operation of a menu setting is performed on the imaging apparatus 10, there is a low probability that the user is interested in the subject and there is a high probability that the frame 36 is not to be an important frame for the user or the like. The user or the like can specify whether or not the frame 36 is obtained while the operation of the menu setting is performed on the imaging apparatus 10, with reference to the operation-related information 126. Accordingly, it is possible to determine whether or not the frame 36 is an important frame 36 in units of the frame 36.

Further, in the imaging apparatus 10 according to the present eighth modification example, the partial plurality-of-frame-related information 64 includes the representative operation-related information 127. Therefore, the user or the like can understand the operation performed on the imaging apparatus 10 in units of the part of the plurality of frames 36 included in the frame group 34, with reference to the representative operation-related information 127 in the partial plurality-of-frame-related information 64, without reproducing the moving image data 32. Accordingly, it is possible to determine whether or not the frame 36 is an important frame 36 in units of the plurality of frames 36.

### Ninth Modification Example

In the eighth modification example, the embodiment example has been described in which the frame-related information 56 includes the operation-related information 126, and the embodiment example has been described in which the partial plurality-of-frame-related information 64 includes the representative operation-related information 127. However, the present disclosed technology is not limited thereto. For example, the frame-related information 56 and the partial plurality-of-frame-related information 64 may include information related to a sensor that measures the subject (for example, physical quantity indicating current state of subject or feature of subject) in the moving image data 32.

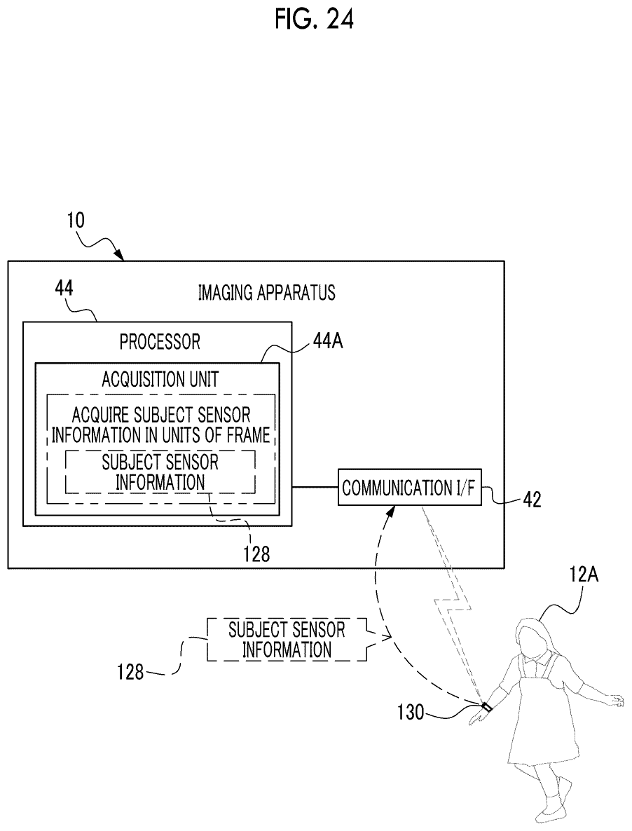

In this case, for example, as shown in FIG. 24, the acquisition unit 44A acquires subject sensor information 128 in units of the frame 36. The subject sensor information 128 is obtained from a sensor attached to the person 12A who is the subject. In the example shown in FIG. 24, a wearable terminal 130 is shown as the sensor attached to the person 12A. The wearable terminal 130 is a wristband-type wearable terminal and is mounted on a wrist of the person 12A. The wearable terminal 130 has a communication function and performs communication with the imaging apparatus 10.

The wearable terminal 130 is equipped with a function of measuring a pulse. The wearable terminal 130 measures the pulse of the person 12A, and transmits information indicating the measured pulse to the imaging apparatus 10 as the subject sensor information 128. In the imaging apparatus 10, the communication I/F 42 receives the subject sensor information 128 transmitted from the wearable terminal 130, and the acquisition unit 44A acquires the received subject sensor information 128.

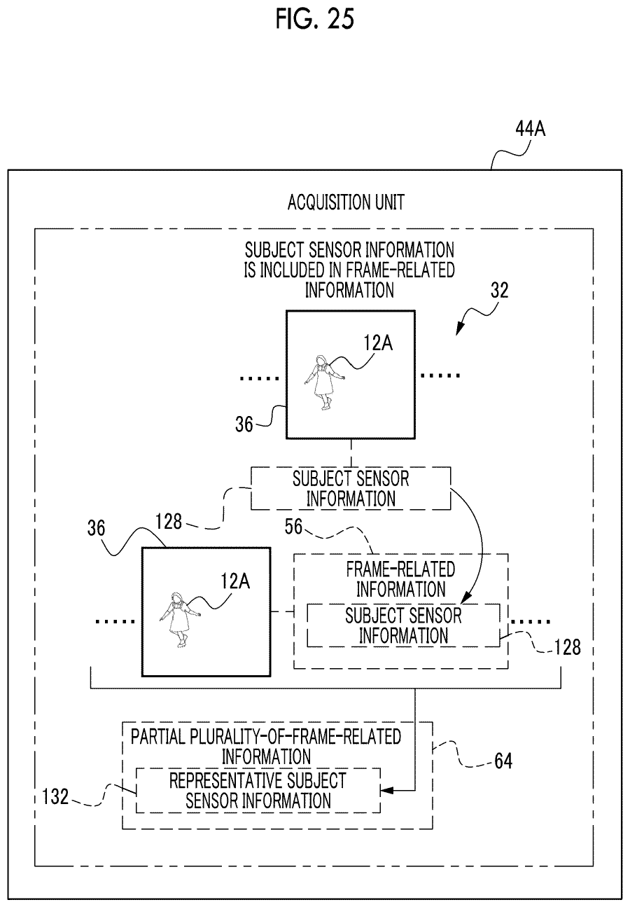

As shown in FIG. 25 as an example, the acquisition unit 44A includes the subject sensor information 128, which is acquired from the wearable terminal 130, in the frame-related information 56 of the corresponding frame 36 (that is, frame 36 in which person 12A shown in FIG. 24 is shown).

Further, the acquisition unit 44A acquires representative subject sensor information 132, and includes the acquired representative subject sensor information 132 in the partial plurality-of-frame-related information 64. The representative subject sensor information 132 is obtained from one or more pieces of subject sensor information 128 included in one or more pieces of frame-related information 56 corresponding to the partial plurality-of-frame-related information 64. For example, the subject sensor information 128 satisfying a designated condition, among the one or more pieces of subject sensor information 128, is set as the representative subject sensor information 132. An example of the representative subject sensor information 132 satisfying a designated condition includes the subject sensor information 128 indicating the highest pulse, among the plurality of pieces of subject sensor information 128 included in all the frame-related information 56 corresponding to the partial plurality-of-frame-related information 64.

In the present ninth modification example, the subject sensor information 128 and the representative subject sensor information 132 are examples of “information related to second sensor that measures subject in moving image data” according to the present disclosed technology.

As described above, in the imaging apparatus 10 according to the present ninth modification example, the frame-related information 56 includes the subject sensor information 128. Therefore, the user or the like can understand a physical state (for example, pulse, blood pressure, or blood glucose level) of the specific subject (for example, person 12A) in units of the frame 36, with reference to the subject sensor information 128 in the frame-related information 56, without reproducing the moving image data 32. For example, in a case where the pulse of the person 12A is high, there is a high probability that the person 12A is excited. That is, there is a high probability that the frame 36 obtained by imaging the person 12A in the excited state is an important frame 36. Further, for example, in a case where the blood pressure of the person 12A is low, there is a high probability that a physical condition of the person 12A is bad. Further, for example, in a case where the present ninth modification example is applied to a scene where the person 12A undergoes an operation at a hospital, it is possible to understand a medical practice that has a large influence on the physical condition of the subject. Therefore, the user or the like can determine whether or not the frame 36 is an important frame 36 in units of the frame 36 with reference to the subject sensor information 128.

Further, in the imaging apparatus 10 according to the present ninth modification example, the partial plurality-of-frame-related information 64 includes the representative subject sensor information 132. Therefore, the user or the like can understand the physical state (for example, pulse, blood pressure, or blood glucose level) of the specific subject (for example, person 12A) in units of the part of the plurality of frames 36 included in the frame group 34, with reference to the representative subject sensor information 132 in the partial plurality-of-frame-related information 64, without reproducing the moving image data 32. Accordingly, it is possible to determine whether or not the frame 36 is an important frame 36 in units of the plurality of frames 36.

In the present ninth modification example, the wearable terminal 130 is exemplified, but this is merely an example. A smartphone or a tablet terminal may be employed, or an electronic apparatus may be employed in which one or more sensors (that is, sensors capable of measuring subject in moving image data 32), such as a thermometer and a sphygmomanometer, are mounted.

Further, in the present ninth modification example, the embodiment example has been described in which the wearable terminal 130 measures the pulse of the person 12A, but this is merely an example. For example, the information to be measured may be biological information such as a blood pressure, a magnitude of breathing, a number of times of breathing, or a blood glucose level of the subject shown in the moving image data 32. Further, the information to be measured is not limited to the biological information. In a case where a production line of a factory or the like is the imaging target region, information measured by a sensor installed in the production line may be employed.

### Tenth Modification Example

In the above embodiment, the outline information and the whole basic information 76 are exemplified as the information to be included in the whole-related information 74, but the present disclosed technology is not limited thereto. For example, the moving image data 32 may be information related to a part of other pieces of moving image data, and the whole-related information 74 may include the information related to the other pieces of moving image data.

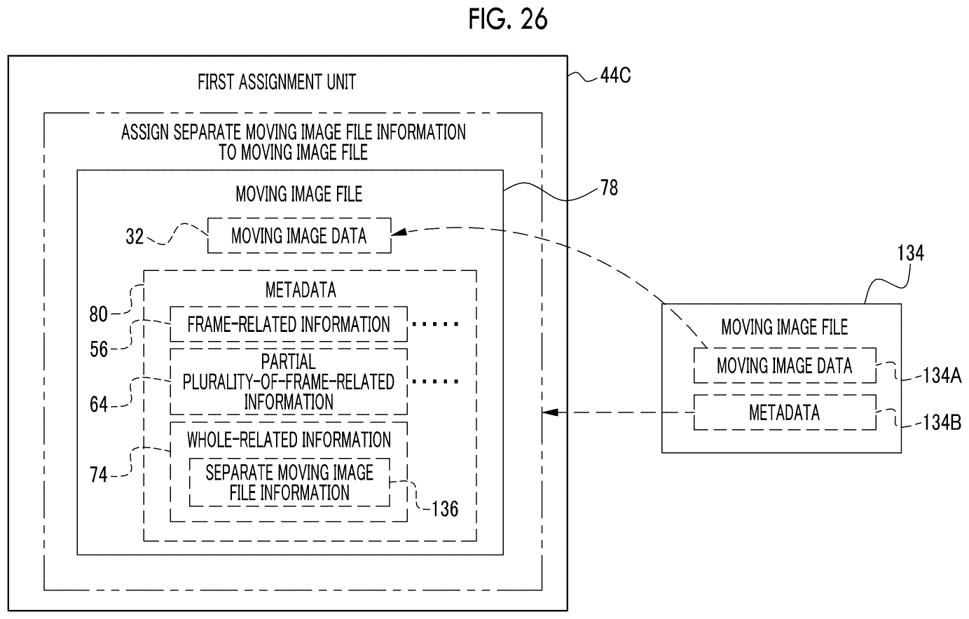

For example, as shown in FIG. 26, in a case where a part of the moving image data 134A included in the moving image file 134, which is different from the moving image file 78, is incorporated into the moving image data 32, the first assignment unit 44C includes separate moving image file information 136 in the whole-related information 74. The separate moving image file information 136 specifies a location of the moving image file 134.

In a case where the moving image file 134 is stored in a memory, such as the NVM 46, the separate moving image file information 136 is, for example, an address in the memory. Further, in a case where the moving image file 134 is present on the Internet, the separate moving image file information 136 is, for example, a uniform resource locator (URL).

For example, in a case where the separate moving image file information 136 is included in metadata 134B of the moving image file 134 and the part of the moving image data 134A is incorporated into the moving image data 32, the first assignment unit 44C acquires the separate moving image file information 136 from the metadata 134B. With the inclusion of the separate moving image file information 136 acquired from the metadata 134B in the whole-related information 74, the first assignment unit 44C assigns the separate moving image file information 136 to the moving image file 78.

As described above, in a case where the part of the moving image data 134A is incorporated into the moving image data 32, the separate moving image file information 136 is included in the whole-related information 74. The separate moving image file information 136 specifies a source location of the part of the moving image data 134A. Therefore, the user or the like can specify which moving image file the part of the moving image data 32 is derived from, with reference to the separate moving image file information 136 in the whole-related information 74, without reproducing the moving image data 32.

In the present tenth modification example, the embodiment example has been described in which the part of the moving image data 134A included in the moving image file 134 is incorporated into the moving image data 32, but the present disclosed technology is not limited thereto. For example, even in a case where a part of the moving image data included in one or more moving image files other than the moving image file 134 is incorporated into the moving image data 32 together with the part of the moving image data 134A, the separate moving image file information 136 may be included in the whole-related information 74, in the same manner as in the present tenth modification example.

Further, in the present tenth modification example, the information for specifying the location of the separate moving image file 134 is exemplified as the separate moving image file information 136, but the present disclosed technology is not limited thereto. The separate moving image file information 136 may include the thumbnail image (for example, thumbnail still image or thumbnail moving image) related to the part of the moving image data 134A, or may include the identifier for identifying the frame included in the part of the moving image data 134A, the number of sheets of frames, or the like. As described above, the separate moving image file information 136 may include the information related to the part of the moving image data 134A.

### Other Modification Examples

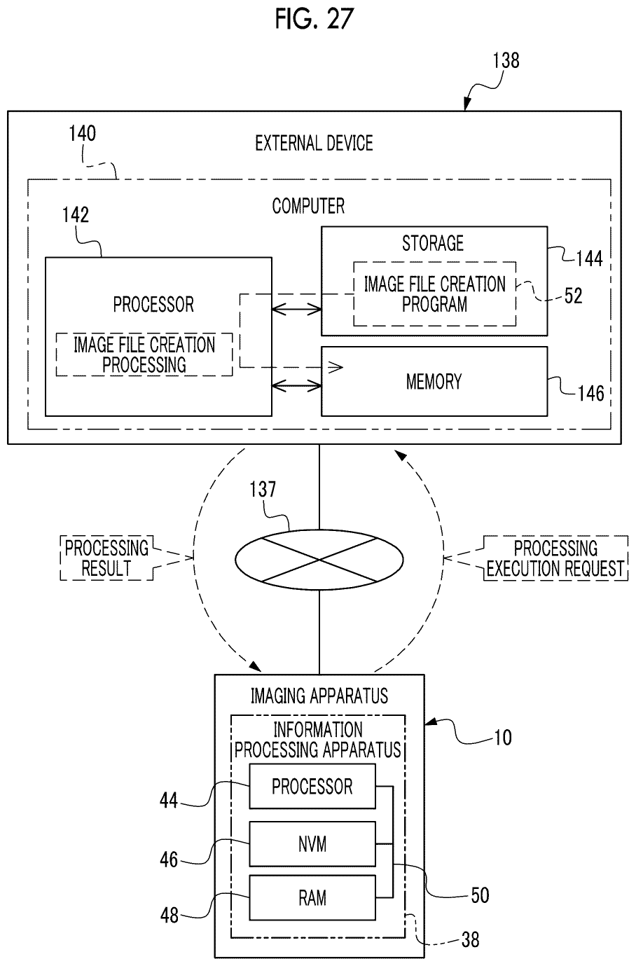

In the above embodiment, the embodiment example has been described in which the information processing apparatus 38 in the imaging apparatus 10 executes the image file creation processing, but the present disclosed technology is not limited thereto. For example, as shown in FIG. 27, the image file creation processing may be executed by a computer 140 in an external device 138 that is communicably connected to the imaging apparatus 10 via a network 137, such as a local area network (LAN) or a wide area network (WAN). An example of the computer 140 includes a server computer for cloud service. The computer 140 is an example of “information processing apparatus” according to the present disclosed technology.

In the example shown in FIG. 27, the computer 140 comprises a processor 142, a storage 144, and a memory 146. The storage 144 stores the image file creation program 52.

The imaging apparatus 10 requests, via the network 137, the external device 138 to execute the image file creation processing. In response to this request, the processor 142 of the external device 138 reads out the image file creation program 52 from the storage 144 and executes the image file creation program 52 on the memory 146. The processor 142 performs the image file creation processing in accordance with the image file creation program 52 executed on the memory 146. The processor 142 provides a processing result obtained by executing the image file creation processing to the imaging apparatus 10 via the network 137.

FIG. 27 shows the embodiment example in which the image file creation processing is executed on the external device 138, but this is merely an example. For example, the imaging apparatus 10 and the external device 138 may execute the image file creation processing in a distributed manner, or a plurality of apparatuses including the imaging apparatus 10 and the external device 138 may execute the image file creation processing in a distributed manner.

In the above embodiment, the embodiment example has been described in which the frame-related information 56, the partial plurality-of-frame-related information 64, and the whole-related information 74 are recorded in the metadata 80 of the moving image file 78, but the present disclosed technology is not limited thereto. For example, the frame 36 may be extracted from the moving image data 32 of the moving image file 78, the image file may be generated for the extracted frame 36, and the frame-related information 56, the partial plurality-of-frame-related information 64, and the whole-related information 74 may be added to the generated image file. As the image file in this case, an image file in a format that allows additional information to be added to a region different from the image data (that is, recordable format) is used.

The format of the moving image file may be any file format that allows the additional information to be added to the region different from the image data.

As the file format, any of moving picture experts group (MPEG)-4, H.264, motion jpeg (MJPEG), high efficiency image file format (HEIF), audio video interleave (AVI), QuickTime file format (MOV), windows media video (WMV), or flash video (FLV) may be used. From the viewpoint of assigning the metadata (additional information) described in the above embodiment, the moving image data of the HEIF is preferably used.

An item of the additional information and the number of pieces of additional information that can be added to the image file is changed according to the file format. Further, with update of version information of the image file, the additional information for a new item may be added. The item of the additional information means a viewpoint in adding the additional information (that is, category in which information is classified).

In the above embodiment, the embodiment example has been described in which the NVM 46 stores the image file creation program 52, but the present disclosed technology is not limited thereto. For example, the image file creation program 52 may be stored in a portable computer-readable non-transitory storage medium, such as an SSD, a USB memory, or a magnetic tape. The image file creation program 52 stored in the non-transitory storage medium is installed in the imaging apparatus 10. The processor 44 executes image file creation processing in accordance with the image file creation program 52.

Further, the image file creation program 52 may be stored in a storage device of another computer, a server device, or the like connected to the imaging apparatus 10 via a network, the image file creation program 52 may be downloaded in response to a request of the imaging apparatus 10, and the image file creation program 52 may be installed in the imaging apparatus 10.

There is no need to store the entire image file creation program 52 in the storage device of another computer, a server device, or the like connected to the imaging apparatus 10 or the NVM 46, and a part of the image file creation program 52 may be stored.

Further, the information processing apparatus 38 is built into the imaging apparatus 10 shown in FIG. 2, but the present disclosed technology is not limited thereto. For example, the information processing apparatus 38 may be provided outside the imaging apparatus 10.

In the above embodiment, the embodiment example has been described in which the present disclosed technology is realized by the software configuration, but the present disclosed technology is not limited thereto. A device including an application specific integrated circuit (ASIC), a field programmable gate array (FPGA), or a programmable logic device (PLD) may be applied.

Further, a combination of a hardware configuration and a software configuration may be used.

As a hardware resource for executing the image file creation processing described in the above embodiment, various processors shown below can be used. Examples of the processor include software, that is, a CPU, which is a general-purpose processor that executes a program to function as the hardware resource for executing the image file creation processing. Further, examples of the processor include a dedicated electronic circuit which is a processor having a circuit configuration designed to be dedicated to execute specific processing, such as the FPGA, the PLD, or the ASIC. A memory is incorporated in or connected to any processor, and any processor uses the memory to execute the image file creation processing.

The hardware resource for executing the image file creation processing may be configured with one of these various processors or may be configured with a combination of two or more processors of the same type or different types (for example, a combination of a plurality of FPGAs or a combination of a CPU and an FPGA). Further, the hardware resource for executing the image file creation processing may be one processor.

As an example of configuring with one processor, first, one processor is configured with a combination of one or more CPUs and software, and there is an embodiment in which this processor functions as the hardware resource for executing the image file creation processing. Second, as represented by System-on-a-chip (SoC) or the like, there is a form in which a processor that realizes all functions of a system including a plurality of hardware resources for executing the image file creation processing into one integrated circuit (IC) chip is used. As described above, the image file creation processing is realized by using one or more of the various processors as the hardware resource.

Furthermore, as the hardware structure of these various processors, more specifically, it is possible to use an electronic circuit in which circuit elements, such as semiconductor elements, are combined. Further, the image file creation processing described above is merely an example. Therefore, it is needless to say that removal of an unnecessary step, addition of a new step, and change of processing procedure may be employed within a range not departing from the gist.

The above contents and the above-shown contents are detailed descriptions for parts according to the present disclosed technology, and are merely examples of the present disclosed technology. For example, the descriptions regarding the configurations, the functions, the actions, and the effects are descriptions regarding an example of the configurations, the functions, the actions, and the effects of the part according to the present disclosed technology. Accordingly, in the contents described and the contents shown hereinabove, it is needless to say that removal of an unnecessary part, or addition or replacement of a new element may be employed within a range not departing from the gist of the present disclosed technology. In order to avoid complication and easily understand the part according to the present disclosed technology, in the contents described and the contents shown hereinabove, the description regarding common general technical knowledge or the like which is not necessarily particularly described for enabling implementation of the present disclosed technology is omitted.

In the present specification, the grammatical concept of “A or B” includes the concept of “any one of A or B” as well as the concept synonymous with “at least one of A or B”. That is, “A or B” includes meaning that it may be only A, only B, or a combination of A and B. In the present specification, in a case where three or more matters are represented by “or” in combination, the same concept as “A or B” is applied.

In a case where all of documents, patent applications, and technical standard described in the specification are incorporated in the specification as references, to the same degree as a case where the incorporation of each of documents, patent applications, and technical standard as references is specifically and individually noted.

What is claimed is:

1. An image file comprising:
moving image data including a frame group; and
accessory information,
wherein the moving image data incorporates a part of other pieces of moving image data contained in a separate image file that is an image file different from the image file,
the accessory information includes first accessory information and second accessory information,
the first accessory information relates to all frames included in the frame group, and information related to the other pieces of moving image data, and
the second accessory information relates to a part of a plurality of frames in the frame group.

2. The image file according to claim 1,
wherein the information related to the other pieces of moving image data includes information specifies a location of the separate image file.

3. The image file according to claim 1,
wherein the separate image file has metadata,
the metadata includes the information related to the other pieces of moving image data, and
the first accessory includes the information related to the other pieces of moving image data obtained from the metadata.

4. The image file according to claim 1,
wherein the first accessory information includes information related to a configuration of the moving image data.

5. The image file according to claim 1,
wherein the second accessory information further includes information related to one frame included in the frame group.

6. The image file according to claim 5,
wherein the second accessory information includes scene information related to a scene specified from the part of the plurality of frames or a scene specified from the one frame.

7. The image file according to claim 1,
wherein the second accessory information includes change information related to a change of a subject in the moving image data or a change of a position, an orientation, or an angle of view of an imaging apparatus used for imaging to obtain the moving image data.

8. The image file according to claim 7,
wherein the change information includes information related to tracking of the subject or information related to a movement of the imaging apparatus.

9. The image file according to claim 1,
wherein the second accessory information includes information related to a first sensor provided in an imaging apparatus used for imaging to obtain the moving image data.

10. The image file according to claim 1,
wherein the second accessory information includes information related to a second sensor that measures a subject in the moving image data.

11. The image file according to claim 1,
wherein the second accessory information includes information related to an operation to an imaging apparatus used for imaging to obtain the moving image data.

12. The image file according to claim 1,
wherein the second accessory information includes information corresponding to a recording time at which a subject in the moving image data is recorded.

13. An information processing apparatus comprising:
a processor that generates the image file according to claim 1.

14. An imaging apparatus comprising:
a sensor that is used for imaging of the moving image data included in the image file according to claim 1; and
a processor that generates the image file based on a signal output from the sensor.

15. A generation method of generating an image file including moving image data including a frame group and accessory information,
wherein the moving image data incorporates a part of other pieces of moving image data contained in a separate image file that is an image file different from the image file,
the generation method comprising:
an acquisition step of acquiring the moving image data;
a first assignment step of assigning, to the image file, first accessory information that relates to all frames included in the frame group as the accessory information, and information related to the other pieces of moving image data; and
a second assignment step of assigning, to the image file, second accessory information that relates to a part of a plurality of frames in the frame group as the accessory information.
